(19) United States
(12) Patent Application Publication
(10) Pub. No.: US 2016/0031636 A1
(43) Pub. Date: Feb. 4, 2016

(54) SYSTEM FOR COVERING LIQUID HYDROCARBONS AND METHOD OF FORMING SAME

(71) Applicant: Greatario Industrial Storage Systems Ltd., Innerkip (CA)

(72) Inventors: J. Scott Burn, Innerkip (CA); Terrance J. Frank, Calgary (CA); Steven A. Coppa, Toronto (CA)

(73) Assignee: Greatario Industrial Storage Systems Ltd., Innerkip (CA)

(21) Appl. No.: 14/879,204

(22) Filed: Oct. 9, 2015

Related U.S. Application Data
(63) Continuation-in-part of application No. 14/044,537, filed on Oct. 2, 2013, now Pat. No. 9,187,609.
(60) Provisional application No. 62/202,246, filed on Aug. 7, 2015.

(51) Int. Cl. B65D 88/34; B29C 44/42; B29C 44/08

(52) U.S. Cl. CPC B65D 88/34; B29C 44/08; B29C 44/42; B29K 2077/00

(57) ABSTRACT

A method of forming an element to have a preselected element density, for floating at least partially on a surface of an at least partially liquid hydrocarbon mixture having a known liquid density. The method includes determining the preselected element density based on the known liquid density. A mold cavity is provided that is formed to define an exterior surface of the element with an exterior surface area formed to provide the element having the preselected element density. A polymer resin and a foaming agent are mixed together in preselected proportions to provide a material mixture, which is heated to at least partially liquefy the material mixture. The at least partially liquefied material mixture is injected into the mold cavity over three respective predetermined time periods at three respective velocities, under three respective pressures.

### CROSS-REFERENCE TO RELATED APPLICATIONS

This application is a continuation-in-part of U.S. patent application Ser. No. 14/044,537, filed on Oct. 2, 2013, the entirety of which is hereby incorporated by reference, and this application claims the benefit of U.S. Provisional Application No. 62/202,246, filed on Aug. 7, 2015, the entirety of which is also incorporated by reference.

### FIELD OF THE INVENTION

The present invention is a system for covering liquid hydrocarbons and a method of forming the system.

### BACKGROUND OF THE INVENTION

Fixed-roof, atmospheric pressure storage tanks for liquid hydrocarbons are very common in the petroleum industry. This type of storage tank is known to be a critical source of fugitive volatile organic compound (VOC) and greenhouse gas (GHG) emissions. As is well known in the art, these tanks must be able to maintain ambient pressure (i.e. near zero pressure difference across the tank walls) by direct venting of the internal vapor space to the atmosphere. However, the vented gas stream inevitably contains organic compounds evaporated or released from the liquid phase. Actual vapor emission processes from these tanks are quite complex and are driven by a number of different processes: diurnal heating and cooling (“tank breathing”); evaporative emissions; convective mixing due to temperature differences among the tank liquid, the internal vapor space, and the ambient environment; and liquid level changes that push out vapor from the head space (“working losses”).

In warmer geographical areas, the liquid hydrocarbon storage tanks can be exposed to ambient temperature conditions that are hot enough during daytime to cause a significant amount of vaporization of the volatile liquids and expansion of the headspace vapors which creates VOC emissions from the tank storage facility and causes the facility to incur a material loss of the hydrocarbons. These same geographical areas very often experience significantly cooler nighttime ambient conditions which drives the diurnal heating and cooling process cycle, contributing to the phenomenon referred to as tank breathing. Cooler ambient nighttime conditions cause the gases in the headspace to contract, in turn causing fresh air to be drawn into the storage vessel's headspace. This new fresh air has more capacity to hold VOC vapors and a new cycle of liquid vaporization will occur to saturate the new mixture of gases in the tank headspace.

During the operation of the storage tank, changes in the liquid levels of the contents (e.g., when the amount of liquid is increasing or decreasing) may cause the vapors created in the headspace the of tank to be expelled to the atmosphere generating a material loss (working loss). The working losses are VOC emissions that may be a local safety hazard due to the explosive nature and health effects of these emissions.

Metal floating roof technologies are known that include pontoon style floating structures that rest on the surface of the liquid hydrocarbon. These structures typically have a polymer seal/sweep around the inside circumference of the tank that prevents liquids from escaping upwardly from under the floating roof. The floating roof structures are typically also supported by complex internal tank supports or by mechanical arms that attach the floating roof to walls of the tank.

The floating roof structure is intended to minimize VOC emissions from the liquid hydrocarbons. In one type thereof, the floating roof structure is the only roof on the tank, i.e., the floating roof is exposed to the atmosphere. Since rainwater or snow will accumulate inside the tank, on the floating structure, there must also be a system to allow the draining of accumulated water from the floating roof, to prevent the water from getting into the liquid hydrocarbons inside the tank. Drainage of water from the floating roof is desirable also because, if the water is not drained therefrom, it may accumulate to the extent that its weight may cause the floating roof structure to sink. The floating roofs eliminate the need for a fixed roof structure but they also leave the emptied portion of the tank exposed to the environment. Due to the risk of metal to metal contact from the floating roof steel with the tank perimeter (i.e., when polymer seals have failed), these roof systems usually require fire suppression systems to prevent a disaster should a spark occur from a seal failure.

Floating internal pontoon roofs (i.e., positioned inside a fixed roof tank), are also known. Due to the position of the floating pontoon roof inside a fixed roof tank, water does not accumulate on this type of floating roof, and therefore drainage of water therefrom is not required. However, these internal roofs tend to be very expensive to install and maintain since they are inside a fixed roof tank. Fire suppression systems are also needed for the tank headspace above the floating roof, inside the fixed roof, because of the fire risk due to a metal to metal contact that may cause friction and sparking. These internal tank floating roofs are feasible only in certain sizes of tanks, and are impractical for very large storage tanks.

In summary, in the prior art, there are two types of floating (or “pontoon”) roof structures, each with its advantages and disadvantages relative to the other. However, the known floating roof structures have the disadvantage that they necessarily involve significant vapor losses. In general, the vapor losses appear to be the result of traces of liquid hydrocarbons left on the tank walls when the level of the liquid decreases (i.e., causing the floating structure to be lowered), and they are also due to leakage of the VOCs and GHGs from the floating structure. Such leakage may take place, for instance, where the membrane engages the tank wall.

In some instances, vapor recovery units (“VRU's”) are used in a tank with a fixed roof to capture the vapor that is released inside the tank headspace, before it is released to the atmosphere. The VRU may be used, for instance, where the tank includes an internal floating structure and the fixed roof. Typically, the VRU cools and compresses the volatile vapors to condense them into liquids for burning off in a flare system, or for collection and storage for further use into the hydrocarbon processing facility. A VRU system may collect, for example, approximately 95% of the vapors generated. The main disadvantage of the VRU system is that it is extremely expensive, both in capital cost and in maintenance and operating utility costs. Also, if the VRU system malfunctions or ceases operating, then the tank vent emissions will go into the atmosphere, unimpeded, while the VRU is offline. Typically, malfunctioning is due to the VRU freezing, because of water vapor condensing within the tank vent vapor flow to the VRU. This can happen in areas of high humidity or during cold weather conditions.

The various types of liquid hydrocarbons that may be stored can be identified in the following categories: conventional light oil; conventional medium-heavy oil; conventional heavy oil; bitumen; diluted bitumen (dilbit); and diluents. These liquid hydrocarbons contain different proportions of light hydrocarbon fractions, which will vaporize, under the appropriate temperature and ambient pressure conditions. A conventional oil storage tank in a warm climate has the potential to lose a substantial proportion of its contents due to volatilization of the liquid hydrocarbons inside the tank when temperatures become sufficient to drive off the light fractions of the liquid.

A light hydrocarbon, e.g., pentane, or natural gas condensates is a suitable diluent. Diluted bitumen (referred to as dilbit) is a mixture of bitumen and diluent. Dilbit typically is about 30% by weight diluent. Bitumen has relatively little volatile fraction, however it is typically stored in dilbit, at about 35° C. The typical storage temperature of 35° C. is very close to flashing temperatures. Because of the diluent content, the stored dilbit typically is subject to high vapor losses.

Pentane as an example is commonly used as a diluent for the transport of bitumen to upgrading facilities, with a density of 0.626 g/cc and a boiling point of 36.1° C.

As is well known in the art, the viscosity of the dilbit is much less than that of bitumen. Accordingly, pipeline frictional losses are much lower, and flow rates are much higher, for dilbit. Dilbit typically is stored in large tanks called “sales tanks” that serve as a storage capacity buffer between the producing facility and the pipeline capacity, or trans-loading facilities used to load dilbit into railcars for transport to distant refineries.

The typical sales tank facility for dilbit storage is a fixed roof storage tank with a VRU system. The tank headspace vapors collected by the VRU are typically burned to generate steam for a SAGD facility. In the alternative, natural gas may be burned to generate steam for the SAGD facility. Because diluent is much more expensive than natural gas, burning the diluent captured in the VRU system is disadvantageous.

Floating segmented covers are known that typically are made from recycled polypropylene/high-density polyethylene (HDPE) or polyethylene (PE) that is chemically foamed to a specific gravity of at least 0.5 (i.e., a density of not less than 0.5 g/cc (approximately 31.2 lbs./cu. ft.)). This density is due to the nature of the material and technical and processing limitations, as is known in the art. These covers are made of several cover components and are only intended for water and wastewater applications, where the specific gravity of the fluid covered is approximately 1.0. With a specific gravity of 0.5 (i.e., a density of approximately 0.5 g/cc (approximately 31.2 lbs./cu. ft.)) these prior art cover components initially can float on the surface of an aqueous liquid with the liquid waterline positioned substantially at the center of the cover component. For instance, the wastewater may include manure, and the cover is intended to impede and obstruct the release of noxious odors and potentially harmful vapors from the wastewater.

However, it has been found that, over time, the prior art cover components absorb and/or adsorb water into the cellular structure of the foamed polymer. They therefore become heavier (i.e., more dense) over time. When the specific gravity of the cover component is greater than 0.5 (i.e., a density of 0.5 g/cc (approximately 31.2 lbs./cu. ft.)), the liquid level is above the vertical center of the cover component, i.e., allowing liquid to be above at least part of the cover component. At that point, the cover components are no longer covering the surface of the wastewater, and the odors and vapors escape from the wastewater. It can be seen, therefore, that the prior art foamed polypropylene, HDPE, or PE cover components are effective for only a limited period of time when they are used on water.

The prior art foamed polypropylene covers have been tested in a heated mixture of heavy crude oil, water, and sediment. Such prior art covers have been found to be unsatisfactory in this context, for a number of reasons. In particular, the prior art covers tend to sink within a relatively short time after being positioned on the heated mixture. Based on the testing done to date, it appears that there are at least three distinct reasons why the prior art covers do not function properly when positioned in and on the mixture in the collection tank.

First, the density of the prior art cover components is too high. The liquid hydrocarbon mixture typically has a specific gravity of about 0.8-0.9 (i.e., a density of about 0.8-0.9 g/cc (approximately 49.9-56.2 lbs./cu. ft.)). In order for the cover component to be less than about 50 percent submerged initially, the prior art cover component would need a specific gravity less than about 0.5 (i.e., a density of less than about 0.5 g/cc (approximately 31.2 lbs./cu. ft.)). Accordingly, the prior art cover components tend to sink promptly when positioned on the mixture. When the cover component is more than about 50 percent submerged, the mixture is on top of at least part of the cover component, and the cover components therefore do not substantially cover the surface.

Second, it is believed that the heavy crude oil migrates (i.e., it is absorbed and/or adsorbed) relatively quickly into the foamed cellular structure of the prior art cover components. The prior art chemically foamed polymer cover components, made of polypropylene or polyethylene (as described above), appear to allow the diffusion of hydrocarbons and water through the cellular structure of the polymer wall thereof relatively quickly. This causes the prior art cover component to gain weight relatively quickly and sink further into the liquid, quickly rendering it largely submerged and ineffective.

Third, the prior art foamed polypropylene, HDPE, and PE cover components are not chemically compatible with the hydrocarbons, i.e., these materials are soluble in hydrocarbons. Also, the elevated operating temperatures encountered in the crude oil collection tanks tend to accelerate the polypropylene, HDPE, and PE degradation.

### SUMMARY OF THE INVENTION

For the foregoing reasons, there is a need for a system and a method that overcome or mitigate one or more of the disadvantages or defects of the prior art. Such disadvantages or defects are not necessarily included in those described above.

In its broad aspect, the invention provides a method of forming one or more elements to have a preselected element density, for floating at least partially on a surface of an at least partially liquid hydrocarbon mixture having a known liquid density. The method includes determining the preselected element density based on the known liquid density, the preselected element density being not greater than a predetermined proportion of the known liquid density. A mold cavity is provided that is formed to define an exterior surface of the element with an exterior surface area formed to provide the element having the preselected element density. A polymer resin and a foaming agent are mixed together in preselected proportions to provide a material mixture. The material mixture is heated, to at least partially liquefy the material mixture. The at least partially liquefied material mixture is injected into the mold cavity over a predetermined first time period at a predetermined first velocity and under a predetermined first pressure to provide a first layer of first material at least partially forming the exterior surface of the element. At the end of the first predetermined time period, the at least partially liquefied material mixture is injected into the mold cavity over a predetermined second time period at a predetermined second velocity that is less than the first velocity, and under a predetermined second pressure that is less than the first pressure, to provide a second layer of second material on the first material that is less dense than the first material. At the end of the second predetermined time period, the at least partially liquefied material mixture is injected into the mold cavity over a predetermined third time period at a predetermined third velocity that is less than the second velocity, and under a third pressure that is less than the second pressure, to provide a third layer of third material that is less dense than the first material.

In another of its aspects, the invention provides the element formed according to the method described above, and including a central plate partially defined by a central plane, and an at least partially spherical central part centrally located on the central plate. The central part is at least partially defined by a central axis thereof positioned orthogonal to the central plane. The element also includes a number of ribs converging at points on opposite sides of the central part that are aligned with the central axis.

In another aspect, the invention provides a system having a number of the elements including spherical central parts and formed as described above, in which the elements are engaged with each other to substantially cover the surface of the liquid hydrocarbon mixture, for impeding emission of vapors from the liquid hydrocarbon mixture via the surface thereof.

In yet another of its aspects, the invention provides the element formed according to the method described above, and including a central plate partially defined by a central plane, and an at least partially ellipsoid central part centrally located on the central plate. The central part is at least partially defined by a central axis thereof positioned orthogonal to the central plane. The element also includes a number of ribs converging at points on opposite sides of the ellipsoid central part that are aligned with the central axis.

In another aspect, the invention provides a system having a number of the elements including ellipsoid central parts and formed as described above, in which the elements are engaged with each other to substantially cover the surface of the liquid hydrocarbon mixture, for impeding emission of vapors from the liquid hydrocarbon mixture via the surface thereof.

### BRIEF DESCRIPTION OF THE DRAWINGS

The invention will be better understood with reference to the attached drawings, in which:

FIG. 1A is a top view of an embodiment of an element of the invention, drawn at a larger scale;

FIG. 1B is a cross-section showing an embodiment of the system of the invention positioned on a surface of the mixture in the tank, drawn at a smaller scale;

FIG. 1C is a portion of the cross-section of FIG. 1B, drawn at a larger scale;

FIG. 2A is a side view of the element of FIG. 1A, drawn at a larger scale;

FIG. 2B is a side view of the element of FIG. 1A floating on the surface of the mixture;

FIG. 3 is a top view of an embodiment of a system of the invention floating on the surface of the mixture in the tank, drawn at a smaller scale;

FIG. 4 is an isometric view of the element of FIG. 1A, drawn at a larger scale;

FIG. 5A is an isometric view of the element of FIG. 4 with a portion thereof cut away;

FIG. 5B is a cross-section of another portion of the element of FIGS. 4 and 5A, drawn at a larger scale;

FIG. 6 is a plan view of an alternative embodiment of the element of the invention, drawn at a smaller scale;

FIG. 7A is a plan view of a first part of an embodiment of a mold assembly of the invention, drawn at a smaller scale;

FIG. 7B is a plan view of a second part of the mold assembly of FIG. 7A;

FIG. 7C is a schematic illustration of a barrel of an injection molding machine, and certain components thereof related thereto, drawn at a smaller scale;

FIG. 8 is a cross-section of the mold assembly of FIG. 7A with the first and second parts positioned to define a mold cavity, drawn at a larger scale;

FIG. 9 is a flow chart schematically illustrating an embodiment of a method of the invention;

FIG. 10 is a flow chart schematically illustrating another embodiment of a method of the invention; and

FIG. 11 is a flow chart schematically illustrating an alternative embodiment of a method of the invention;

FIG. 12 is an isometric view of an embodiment of an element of the invention;

FIG. 13 is an elevation view of the element of FIG. 12;

FIG. 14 is a plan view of the element of FIGS. 12 and 13;

FIG. 15A is a cross-section of the element of FIGS. 12-14 taken along line B′-B′ in FIG. 12;

FIG. 15B is a cross-section of the element of FIGS. 12-14 taken along line A′-A′ in FIG. 14;

FIG. 16A is a cross-section of a tank holding liquid hydrocarbons with an embodiment of a system of the invention floating on the liquid hydrocarbons, drawn at a smaller scale;

FIG. 16B is a portion of the cross-section of FIG. 16A, drawn at a larger scale;

FIG. 17 is a side view of the element of FIGS. 12-14 floating on the liquid hydrocarbons, drawn at a larger scale;

FIG. 18 is a top view of the tank of FIG. 16A, partially cut away and with the liquid hydrocarbons therein and the system of FIG. 16A floating on the liquid hydrocarbons, drawn at a smaller scale;

FIG. 19A is a plan view of a first part of an embodiment of a mold assembly of the invention, drawn at a larger scale;

FIG. 19B is a plan view of a second part of the mold assembly of FIG. 19A;

FIG. 19C is a schematic illustration of a barrel of an injection molding machine, and certain components thereof related thereto, drawn at a larger scale;

FIG. 20 is a cross-section of the mold assembly of FIGS. 19A and 19B with the first and second parts positioned to define a mold cavity, drawn at a smaller scale;

FIG. 21A is an isometric view of an alternative embodiment of the element of the invention, drawn at a larger scale;

FIG. 21B is an isometric view of the element of FIG. 21A, partially cut away;

FIG. 21C is a side view of the embodiment of the element illustrated in FIGS. 21A and 21B; and

FIG. 22 is a top view of an embodiment of a system of the invention including the element of FIGS. 21A-21C, drawn at a smaller scale.

### DETAILED DESCRIPTION

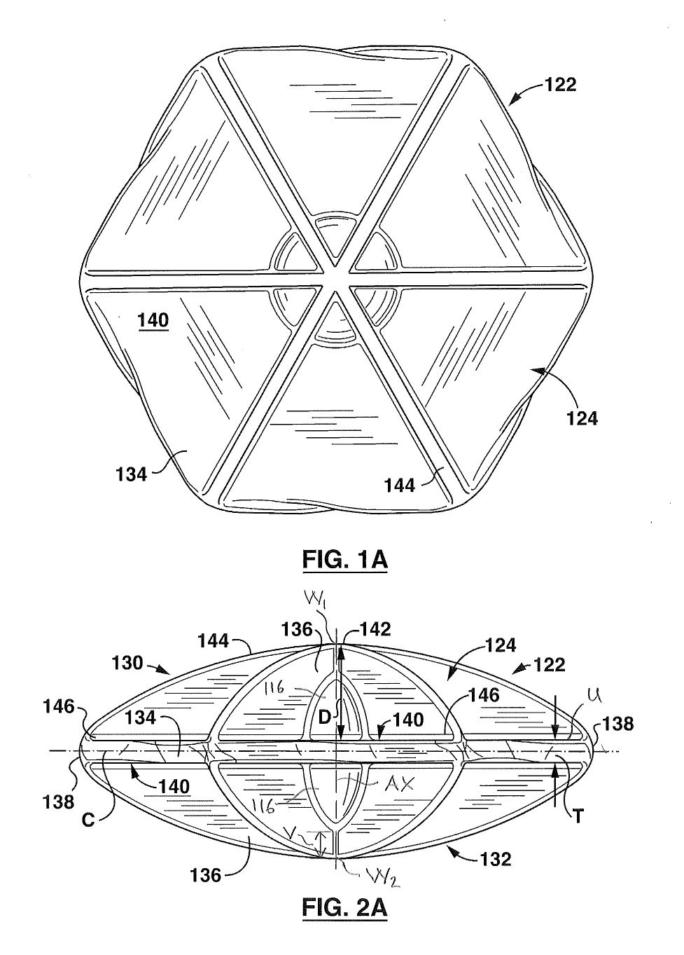

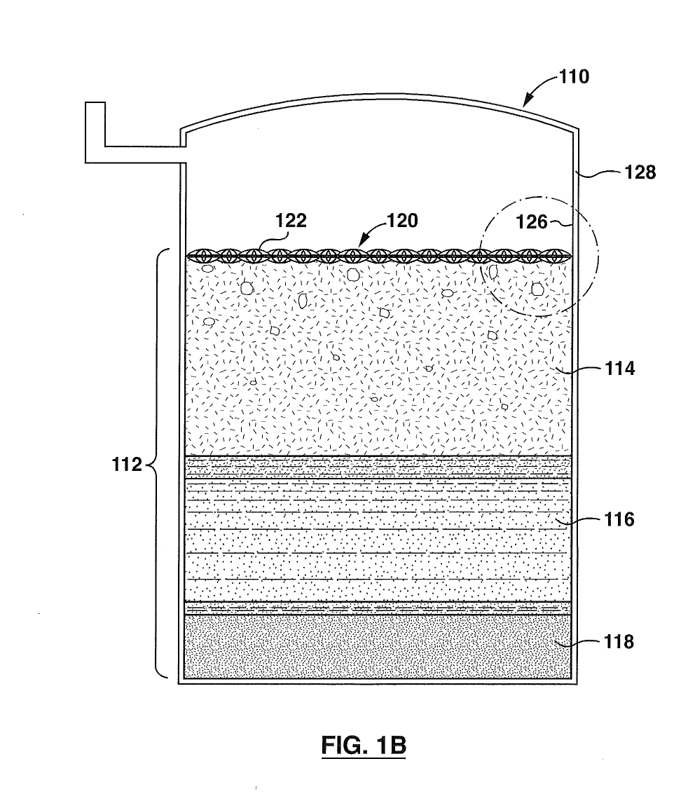

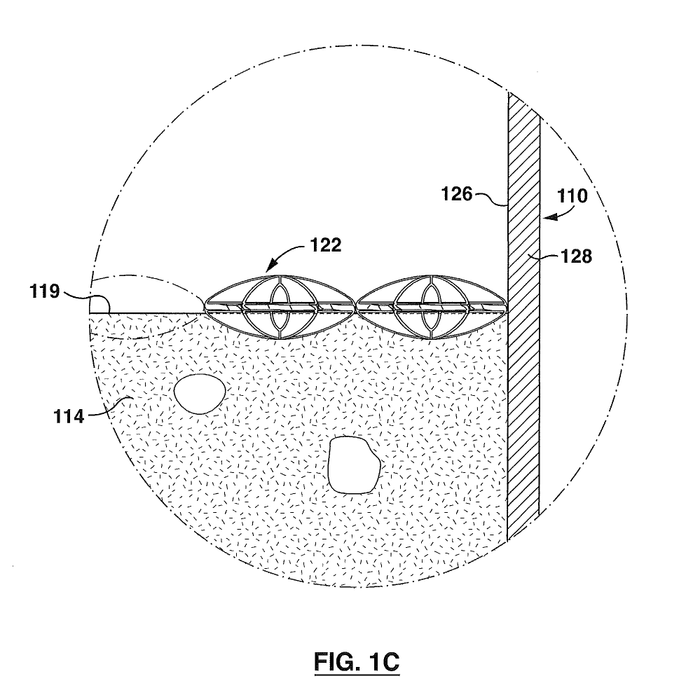

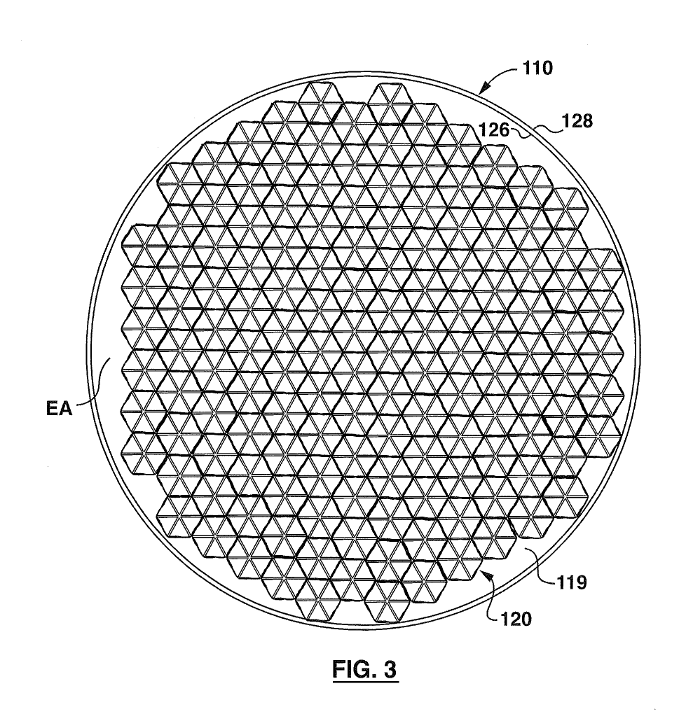

In the attached drawings, like reference numerals designate corresponding elements throughout. Reference is first made to FIGS. 1A-6 and 7A-7B to describe an embodiment of a system in accordance with the invention indicated generally by the numeral 120 (FIG. 1B). Preferably, the system 120 is for substantially covering a surface 119 of a mixture 112 including heavy crude oil 114 in a container 110 (FIGS. 1B, 3). In one embodiment, the system 120 preferably includes a number of elements 122, as will be described.

Those skilled in the art would be aware that heavy crude oil may include water and sediment, and that the heavy crude oil may be “conditioned” while it is in the container 110, to separate at least a part of the water and the sediment from the crude oil. For convenience, the mixture 112 is illustrated in FIG. 1B as having been conditioned. It will be understood that, as discussed above, when first introduced into the container 110, the mixture 112 is not conditioned.

As can be seen in FIGS. 1B and 3, the elements 122 preferably are formed to at least partially float on the mixture 112. Each element 122 preferably includes a body 124. The sizes of these elements 122 are designed specifically relative to the size of the liquid vessel 110 in which they will operate, so that there is a minimum of excess area of the liquid surface 119 that is not covered. It will be understood that, in FIG. 3, the extent of the excess area (identified as “EA” in FIG. 3) is shown as being larger than it preferably would be in practice, for clarity of illustration.

Those skilled in the art would appreciate that the body 124 may have any suitable structure. It is preferred that all of the elements 122 have substantially the same size and shape. Preferably, and as will be described, each of the elements is symmetrical. The symmetrical shape of the elements 122 as illustrated allows them to be randomly deployed into the liquid container 110.

It would also be appreciated by those skilled in the art that the elements 122 may be introduced into the container 110 when the mixture is in the container, or, alternatively, when the container is empty, or substantially empty.

If the elements 122 are deployed when the container 110 contains the mixture 112, then immediately after the elements 122 are deployed into the container 110 onto the mixture 112, they slip off of each other and automatically form an organized single unit or system, engaged with each other at their respective outer edges, at their lowest gravimetrical energy state. Preferably, the elements 122 are sized so that, when on the surface 119 of the mixture 112, they form a substantially continuous cover or system 120 extending over substantially the entire surface 119, i.e., with very little exposed (uncovered) area of the surface 119. As illustrated in FIGS. 1B, 1C and 3, it is preferred that the elements 122 located around the perimeter of the surface generally engage the interior surface 126 of a wall 128 of the container 110.

If the elements 122 are deployed into a container that is empty or substantially empty, then the elements 122 are piled on the floor of the container 110 until the mixture 112 is introduced into the container 110. Due to the rising level of the mixture 112 in the container 110, when the elements 122 begin to float on the mixture 112, the elements 122 slip off each other so that they are all in and on the mixture 112, and their outer edges engage each other, to form the cover 120 extending over substantially the entire surface 119.

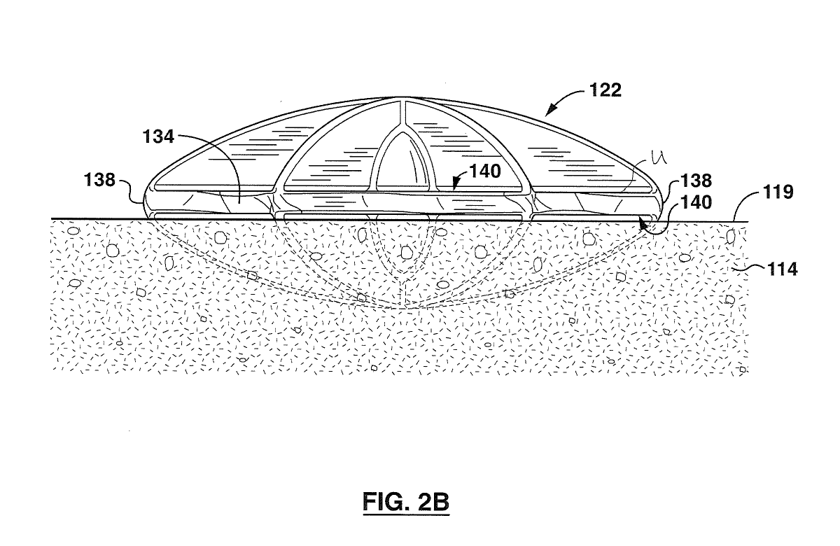

As can be seen in FIGS. 1A, 2A, 2B, and 4, the element of the invention 122 preferably is substantially in the form of a hexagon, in plan view. The body 124 preferably has first and second sides 130, 132 and a central plate 134 therebetween (FIG. 2A). As can be seen in FIG. 2A, it is preferred that the first and second sides 130, 132 are substantially symmetrical relatively to a central plane “C” centrally located in the central plate 134. For the purposes hereof, the side of the deployed element that is held substantially at or below the surface 119 is referred to as the “submerged” side, and the other side (i.e., held substantially above the surface 119) is referred to as the “exposed” side. It will be understood that either the first or the second side may be the submerged side, or the exposed side, as the case may be. Due to the generally hexagonal shape of each element 122, a number of the elements 122 can be engaged with each other to form the system 120, providing a substantially continuous cover or system 120 on the surface 119 of the hydrocarbon mixture (FIG. 3). However, those skilled in the art would appreciate that the elements 122 as illustrated in the enclosed drawings are exemplary only. It will be understood that the elements 122 may have any suitable configuration.

It is preferred that each of the first and second sides 130, 132 includes one or more ridges 136 that are curved, as will be described. As can be seen in FIG. 1A, the central plate 134 preferably includes an outer edge 138 that is engageable with the outer edges of other elements 122, to form the system 120. The curved ridges 136 enable the elements 122 to slide off each other, as noted above, to form the cover (i.e., the system 120) in which the elements 122 engage each other at their outer edges 138 (FIG. 3).

In one embodiment, the element 122 preferably includes a central part 116 substantially centrally located in the body 124. Preferably, the central part 116 is a substantially spherical body defined by a central axis “AX” joined with the ridges 136. The ridges 136 preferably converge at points “W₁”, “W₂” that are aligned with the central axis “AX”.

In one embodiment, the central plate 134 preferably also includes substantially planar portions 140 thereof, located between the ridges 136 respectively and joined to the central part 116. As can be seen in FIG. 2A, in one embodiment, each of the ridges 136 preferably extends a predetermined distance “D” at an inner end 142 of the ridge 136 substantially orthogonally relative to the planar portion 140.

As can be seen in FIG. 2A, the ridges 136 meet at the points of convergence “W₁”, “W₂” that are spaced apart from the central part 116, by a distance “V” in each case.

In one embodiment, it is preferred that the exterior of each of the ridges 136 is defined by a tapered edge 144. Each of the ridges 136 preferably is curved and tapered, so that the tapered edge 144 extends from the inner end 142 of the ridge 136 to an outer end 146 of the ridge 136, at which the tapered edge 144 meets the outer edge 138. Those skilled in the art would appreciate that the tapered edges 144 may have any suitable configuration. As can be seen, for instance, in FIG. 2A, each of the tapered edges 144 preferably defines an arc. Due to the ridges 136, the elements 122 tend not to become hung up on each other when they are first positioned in and on the mixture 112 in the container 110.

In use, the elements 122 preferably are put inside the container 110, to form the system 120. From the foregoing, it can be seen that a sufficient number of the elements 122 preferably is used to substantially cover the surface 119 of the mixture 112. As described above, the elements 122 preferably are sized for the container 110, so as to minimize the exposed area of the surface 119. Those skilled in the art would appreciate that the element may have any suitable dimensions.

There are various factors to be considered in determining the size of the element. For example, for a given surface area of the mixture 112, a smaller-sized element would result in a smaller portion (area) of the surface not being covered once the system is in position, floating at least partially in the mixture. Balanced against this are other factors, for instance, if a larger-sized element is used, fewer elements are required to be handled.

In one embodiment, for example, it has been found that the element 122 is suitably sized for a number of applications if it weighs approximately 286 grams (approximately 0.63 lbs.), and measures approximately 8 inches (approximately 20.3 cm) along each ridge thereof and approximately 3.125 inches (approximately 7.9 cm) in height.

From the foregoing description, it can be also seen that the elements 122 preferably are configured to arrange themselves under the influence of gravity, engaging each other at their respective outer edges 138 into a substantially continuous cover or layer or system 120 which floats, semi-submerged, on the surface 119. Preferably, a sufficient number of the elements 122 is introduced into the container 110 to cover the entire surface 119 (or substantially the entire surface 119, as the case may be), so that the elements 122 pressing against and engaging the interior surface 126 of the wall 128 push against other elements 122 on the surface 119, to minimize gaps between the elements 122 over the entire surface 119 (FIGS. 1B, 1C, and 3). Those skilled in the art would appreciate that, to the extent that there are gaps between the deployed elements 122, or non-covered areas of the surface 119, the effectiveness of the cover is compromised.

As described above, the buoyancy of the elements 122 preferably is such that the central plate 134, at least initially, rides on the surface 119 of the mixture 112, or is slightly above the surface 119 (FIG. 2B). As can be seen in FIG. 2B, when floating on the hydrocarbon mixture 112, the central plate 134 has a generally upwardly facing top surface “U” that preferably is held above the surface 119 of the hydrocarbon mixture 112 due to the element's buoyancy. It is also preferred that the central plate 134 has a thickness (identified as “T” in FIG. 2A) that is sufficient to keep the surface “U” of the central plate 134 generally above the surface 119, even if water or hydrocarbons are absorbed/adsorbed into the polyamide, as will be described.

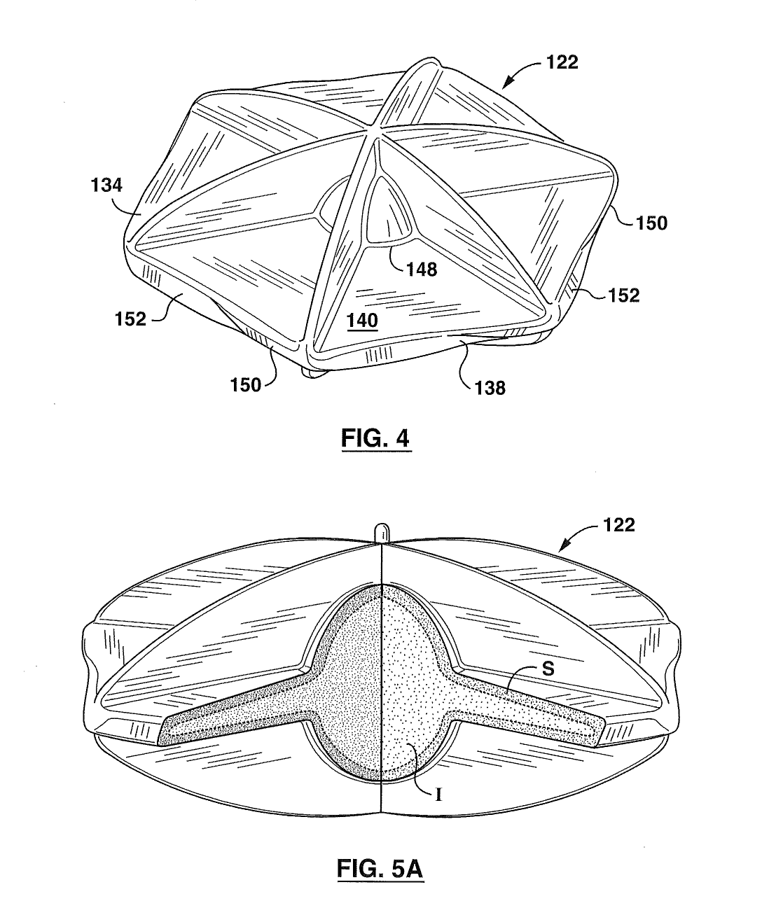

Preferably, the central plate 134 is thicker at an inner edge 148 thereof than at the outer edge 138 thereof (FIG. 4). Accordingly, each of the planar portions 140 of the central plate 134 preferably is tapered from the inner edge 148 to the outer edge 138. Because of this, heavy crude oil that is splashed or otherwise moved onto the exposed (i.e., upper) side of the element 122, e.g., during deployment, is drained off the upper surface “U” of the central plate 134. Those skilled in the art would appreciate that the central plate 134 may be formed having any suitable thicknesses. For instance, in one embodiment, the thickness of the central plate 134 at its inner edge 148 preferably is approximately 1.5 cm (0.59 inch), and the thickness of the central plate 134 at the outer edge 138 is approximately 1.1 cm (0.43 inch).

From the foregoing, those skilled in the art would appreciate that the elements 122 preferably are formed so that they each have a density (i.e., a specific gravity) that enables the element to float. Specifically, it is preferred that the density of the element 122 preferably enables the element 122 to at least partially float on the surface 119, as illustrated in FIG. 2B, so that the upper surface “U” is above the surface 119 of the hydrocarbon mixture, for a certain period of time. As will be described, the position of the element relative to the surface, when the element is floating in and on the mixture 112, is important because the floating elements 122 engage each other to form the system 120, preferably with the least area of the liquid hydrocarbon's surface 119 being left exposed.

As will be described, it appears that the hydrocarbon mixture 112 is slowly adsorbed and/or absorbed into the element 122 over time, gradually increasing its density. Ultimately, the element 122 may become sufficiently dense that the upwardly facing surface “U” is at least partially awash with the hydrocarbon mixture.

It will be understood that the semi-submerged position of the element 122 on the surface 119 is important because it enables the element's central plate 134 to extend in, on, or over, the surface 119. Those skilled in the art would appreciate that, when the central plates 134 of the elements 122 are floating semi-submerged (as illustrated for one element in FIG. 2B), and when the elements 122 engage each other at their outer edges, the surface 119 is substantially covered by the system 120 that the elements 122 collectively form (FIGS. 1B, 1C). In this way, the system 120 preferably impedes, obstructs, or substantially prevents heat and harmful vapours or gases from escaping from the mixture 112 and/or the heavy crude oil 114 via the surface 119.

As noted above, the heavy crude oil typically has a density of about 0.92 g/cc (57.4 lbs./cu. ft.). Because the density of the element, in one embodiment, preferably is between about 0.42 g/cc (approximately 26.2 lbs./cu. ft.) and about 0.46 g/cc (approximately 28.7 lbs./cu. ft.) initially, when the element 122 is floating in and on the mixture (and/or the crude oil thereof), the surface 119 of the mixture 112 is substantially at the midpoint of the elevation of the floating element (FIG. 2B).

As is also noted above, it is preferred that the central plate 134 has a thickness of about 1.1 cm (0.43 inch) at its outer edge. It has been found that this thickness is sufficient to accommodate variations in the liquid density of about 0.8 g/cc (approximately 49.9 lbs./cu. ft.) to about 0.9 g/cc (approximately 56.2 lbs./cu. ft.). As will be described, it is anticipated that, once the element is deployed, the heavy crude oil is slowly adsorbed and/or absorbed into the element. Minor amounts of weight gain by adsorption and/or absorption can also be accommodated by the generous center plate thickness.

Those skilled in the art would appreciate that the density of the mixture 112 when it is first introduced into the container 110 is variable. As noted above, the heavy crude oil may have a density of approximately 0.92 g/cc (approximately 57.4 lbs./cu. ft.). The density of the water portion is approximately 1 g/cc (approximately 62.4 lbs./cu. ft.), and the density of the sediment is much higher. However, it will be understood that the mixture 112 begins to separate into its three main parts (i.e., heavy crude oil, water, and sediment) when it is first introduced into the container 110, and subjected to heat. Accordingly, as a practical matter, the liquid in and on which the element 122 floats substantially has the density of heavy crude oil, i.e., approximately 0.92 g/cc (approximately 57.4 lbs./cu. ft.).

As can be seen in FIGS. 1A, 2A, and 4, in one embodiment, it is preferred that the outer edge 138 of each element 122 includes scallops 150, 152 formed to cooperate with complementary scallops on the outer edges of other elements 122. Those skilled in the art would appreciate that the scallops 150, 152 provide a positive connection between two adjacent deployed elements.

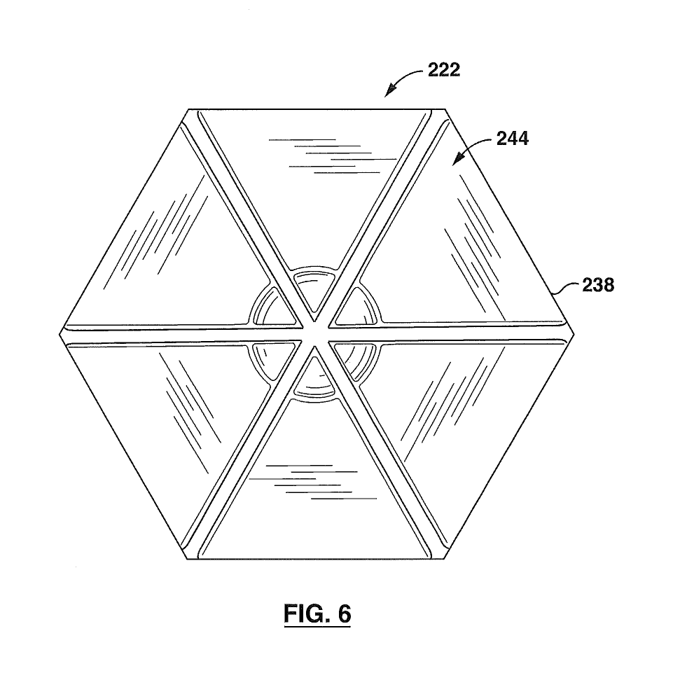

An alternative embodiment of an element 222 of the invention is shown in FIG. 6. In this element, a central plate 244 thereof has outer edges 238 that are substantially straight, i.e., planar, and positioned substantially vertical when the central plate is substantially horizontal.

From the foregoing, it can be seen that the system 120 provides a covering over the mixture 112 that substantially impedes or delays the dissipation of heat from the mixture via the surface 119 thereof. In part, this is due to the insulative effect of the elements 122 that comprise the system 120, impeding radiation of heat from the surface. Also, the elements 122 substantially impede movement of vapors from the surface 119 to the atmosphere. As noted above, not only are the vapors harmful, they also function to dissipate thermal energy into the atmosphere. The net result is that the amount of energy inputs required to maintain the temperature of the mixture at about 80° C. is reduced, because loss of thermal energy is significantly reduced. Also, the volume of vapors released from the mixture into the atmosphere is substantially reduced by the system 120, resulting in less harm to the environment in the vicinity of the container 110.

As described above, in some situations, the well's production rate is so high that the heavy crude oil is removed from the container 110 before the mixture has been heated to 80° C. It has been found that, in these situations, the effect of the system 120 (positioned substantially in the mixture and positioned therein and thereon for substantially covering the surface 119) is sufficiently significant that the mixture is heated to 80° C. in the relatively short time permitted, resulting in significant improvements in subsequent processing of the heavy crude oil.

The system 120 of the invention may also be used in connection with bitumen that has had diluent mixed into it. As is known in the art, bitumen, when mixed with certain diluent, can be pumped. Typically, the diluent is a natural gas liquid, such as, for example, butane, hexane, and heptane. The nature gas liquids may be added at approximately 30 percent by volume, for instance, to result in a mixture of bitumen and diluent that has a viscosity sufficiently low that the bitumen-diluent mixture can be pumped. As noted above, the bitumen-diluent mixture is stored in storage or “sales” tanks, which are a buffer between production, and pipelines to a refinery.

However, as is known, the diluent typically is relatively volatile, and tends to vaporize relatively quickly. The diluent is potentially harmful if released to the atmosphere, and it also would assist in dissipating heat to the atmosphere. To prevent the release of the vaporized diluent into the atmosphere, it is typical to have relatively large vapor recovery units (VRUs) mounted on the storage tanks. As is also noted above, a large capital cost is incurred when the VRU is constructed, and substantial operating costs are also incurred to operate the VRU.

From the foregoing, however, it can be seen that in this situation, the system 120 preferably is deployed to impede and obstruct the release of vaporized diluent into the atmosphere, and also to impede and obstruct the dissipation of heat into the atmosphere. Accordingly, if the system 120 is used to reduce vaporization, however, a smaller VRU may be constructed (thereby reducing capital costs), and the costs incurred in operating the smaller VRUs would also be less. In one embodiment, it is preferred that the system 120 is used to reduce vaporization of the diluent by substantially covering the surface of the bitumen-diluent mixture.

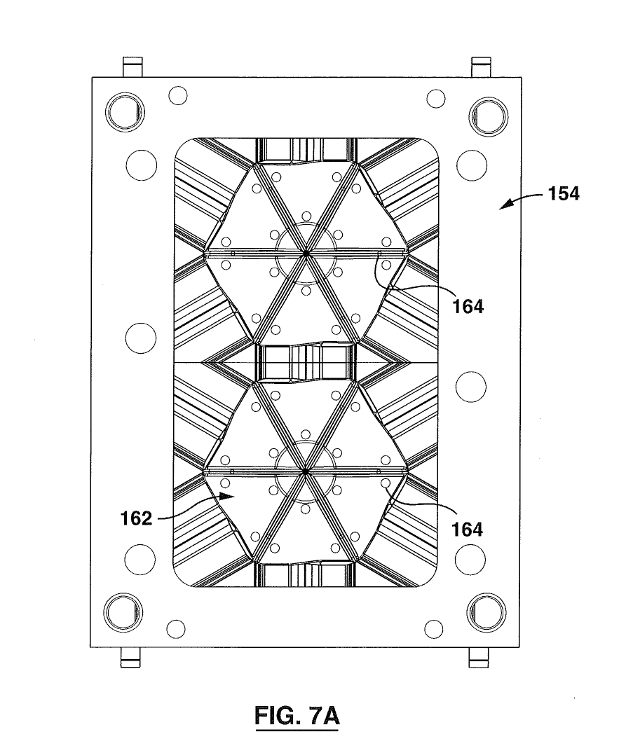

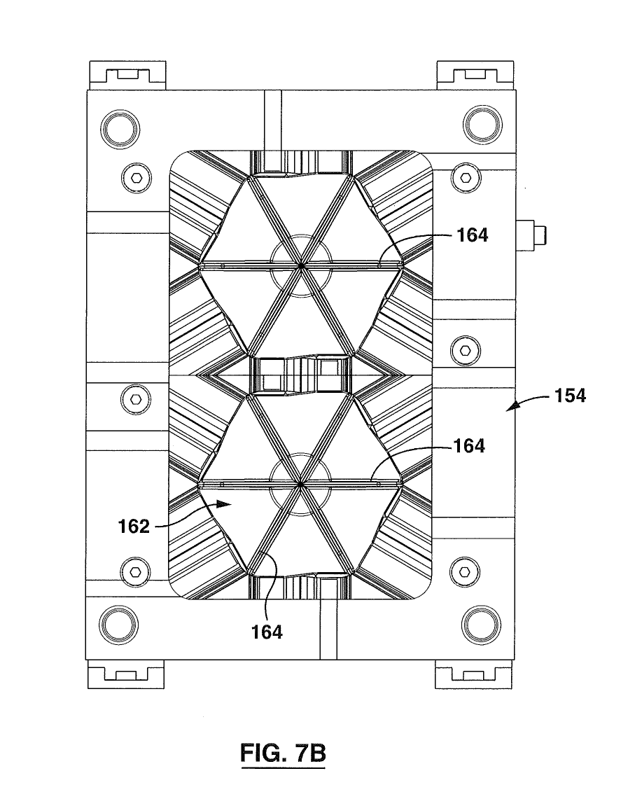

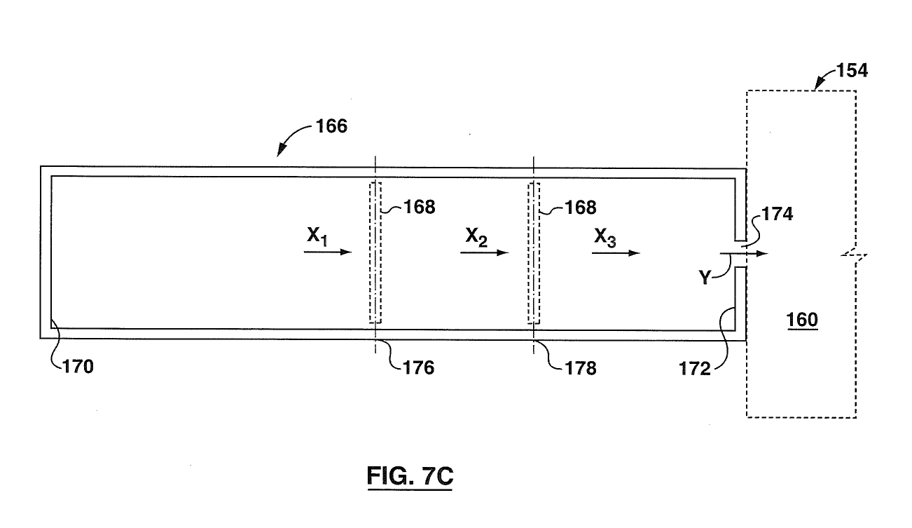

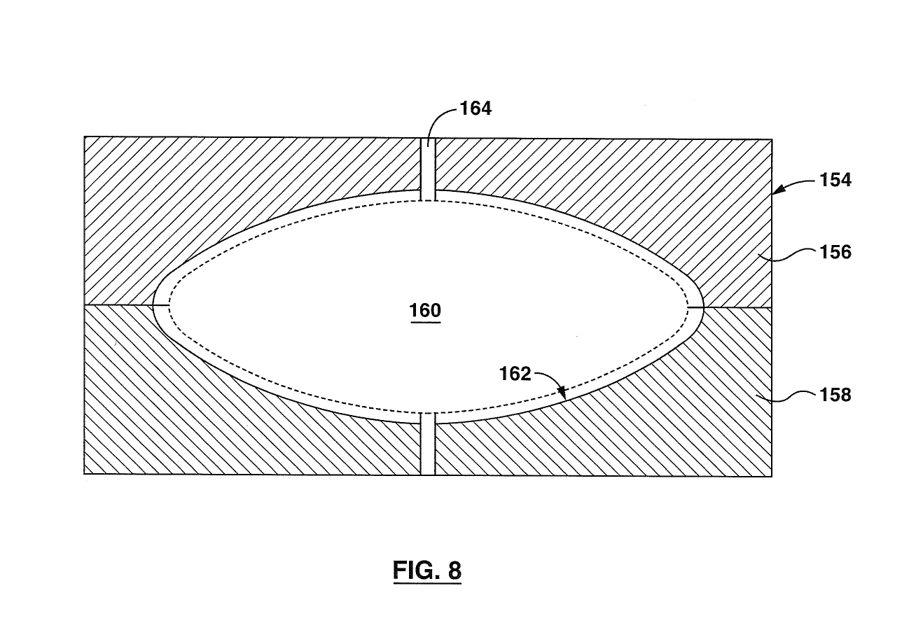

In order to form the element 122, one or more mold assemblies (i.e., tooling) 154 are used. Preferably, a conventional injection molding machine (not shown) is used to inject the material mixture (as hereinafter defined) into the mold assembly 154. As can be seen in FIGS. 7A and 7B, the mold assembly 154 preferably includes first and second parts 156, 158 that are joined together to define one or more mold cavities 160 therein, as shown in FIG. 8. It will be understood that the first and second parts 156, 158 as illustrated each include one half of a mold 162 defining the mold cavity 160.

Vents 164 are provided, to allow gases released during the injection molding process to escape from the mold cavity 160. However, in order to form the element 122 using the methods of the invention described below, it has been found that certain of the vents 164 preferably are substantially larger than conventional vents. Also, there are larger additional vents provided in the mold assembly 154 of the invention.

For example, for an injection molded part made of a certain type of polyamide resin, 18 vents about 0.0005 inch (approximately 0.0013 cm) deep typically would be utilized. It is preferred that the mold assembly 154 includes the typical 18 vents. However, in addition to the aforesaid 18 vents, the mold assembly 154 may include another 12 vents, each measuring about 0.016 inch (approximately 0.04 cm) deep in the rib areas, and another 12 vents, measuring about 0.006 inch (approximately 0.015 cm) each on the parting line, and on about 0.008 inch (approximately 0.02 cm) deep on the center ball area. The additional, and unusually large, vents serve to regulate varying cavity pressures due to the complex geometry of the element 122 and facilitate the egress of gaseous byproducts generated during the chemical foaming process. For clarity, it will be understood that the vents are generally referred to by the reference numeral 164, regardless of whether the vents are “standard” or typical, or additional, and/or larger than typical vents.

Only the mold assembly 154 is shown in FIGS. 7A, 7B, and 8. A barrel 166 of a conventional injection molding machine is schematically illustrated in FIG. 7C, as will be described. It will be understood that the injection molding machine is conventional, however, the manner in which the machine is used is unconventional.

In one embodiment, it is preferred that the element 122 is made of a suitable polyamide polymer resin. It is also preferred that the polyamide resin is a suitable nylon, due to nylon's resistance to degradation when immersed in hydrocarbons. Preferably, the polyamide polymer resin is nylon 6, 12 (referred to herein as “Nylon 612”). This resin is preferred because Nylon 612 tends not to degrade when in contact with the hydrocarbon mixture 112. Those skilled in the art would be aware of other resins that may be suitable for use in the hydrocarbon mixture 112.

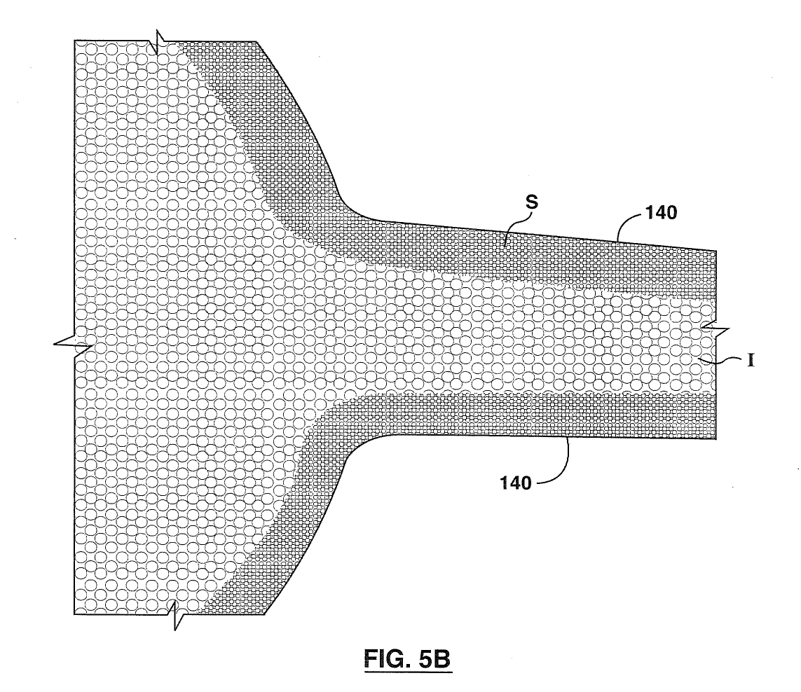

However, because Nylon 612 has a specific gravity of approximately 1.07, and the heavy crude oil may have a specific gravity of approximately 0.92, it is necessary to reduce the density of the Nylon 612 when the element 122 is formed. As noted above, due to the desired positioning of the surface “U” relative to the surface 119 when the element 122 is first floated in the liquid hydrocarbon mixture, the element 122 preferably has an initial density (i.e., prior to adsorption/absorption of the liquid hydrocarbons into the element 122) of approximately 0.46 g/cc or slightly more, i.e., approximately one-half to about 60 percent of the density of the liquid hydrocarbons 112. As will be described, this reduction in density preferably is achieved by utilizing a foaming agent according to the method of the invention. The Nylon 612 resin and the foaming agent preferably are mixed together to form a material mixture, that is injected into the mold cavity. Due to the foaming agent and the process herein of injection molding, the material forming the element 122 preferably is in the form of a matrix of Nylon 612 around a number of voids, or bubbles (FIGS. 5A, 5B).

The Nylon 612 resin has a melt flow (measured according to ASTM D1238) of approximately 15 or 16. It would be appreciated by those skilled in the art that a material with such a high melt flow tends to be relatively easily flowable, and consequently tends to be difficult to foam. Accordingly, the process herein is unique, and also surprising.

It appears that, when the element 122 is floating in and on the hydrocarbon mixture 112, the heavy crude oil 114 (and possibly water) of the mixture 112 is adsorbed and/or absorbed into the element, over an extended period of time. At present, the mechanism of infiltration of the element by the heavy crude oil 114 is not well understood. For the purposes hereof, “adsorption/absorption” shall be understood to refer to adsorption or absorption or both adsorption and absorption, or combinations thereof.

At this point, it is not known how long the element 122 of the invention may float in and on the mixture 112 in a suitable position relative to the surface (as described herein) before its density becomes too high, due to adsorption/absorption of the heavy crude oil into the element 122. It is believed that the element 122 may continue to function acceptably, floating in the desired position relative to the surface 119, over an extended period of time.

In order to minimize the adsorption/absorption of the heavy crude oil and other liquids into the element, it is preferred that the element 122 has an internal structure in which a skin region (“S”) of fine cells surrounds an interior region (“I”) having a coarser cellular structure (FIGS. 5A, 5B). In particular, it is preferred that the element 122 is formed so that a substantially uniform cell structure is provided in each of the skin region “S” and the interior region “I”. This structure is thought to provide two barriers to adsorption/absorption of the heavy crude oil. Initially, the heavy crude oil is adsorbed/absorbed into the finer cellular structure of the skin region “S”. Those skilled in the art would appreciate that, due to the relatively fine cellular structure, the adsorption/absorption of the heavy crude oil into the skin region “S” is likely to take some time. Next, i.e., after the heavy crude oil is adsorbed/absorbed into the skin region “S”, the heavy crude oil permeates into the coarser cells of the interior region “I”. If the cellular structure is substantially uniform then there are no relatively large internal openings, and the heavy crude oil is only able to permeate the element 122 one cell or void at a time. In this way, the substantially uniform cellular structure is believed to significantly delay the adsorption/absorption of the heavy crude oil into the element 122.

It will be understood that, although the matrix and the voids are illustrated in FIGS. 5A and 5B as being uniform in each respective layer, the voids in each respective layer may differ from each other, in relatively minor ways. The internal structure as illustrated in FIGS. 5A and 5B is a schematic representation thereof.

In use, the elements 122 are deployed in the container 110 either after the mixture 112 has been introduced therein, or before. As described above, a sufficient number of the elements 122 is used that the surface 119 of the mixture 112 is substantially covered by the elements 122. The elements 122 are allowed to position themselves under the influence of gravity so that they engage each other at their respective outer edges 138 across the surface 119, the elements being constrained by engagement with the interior surface 126 of the container wall 128.

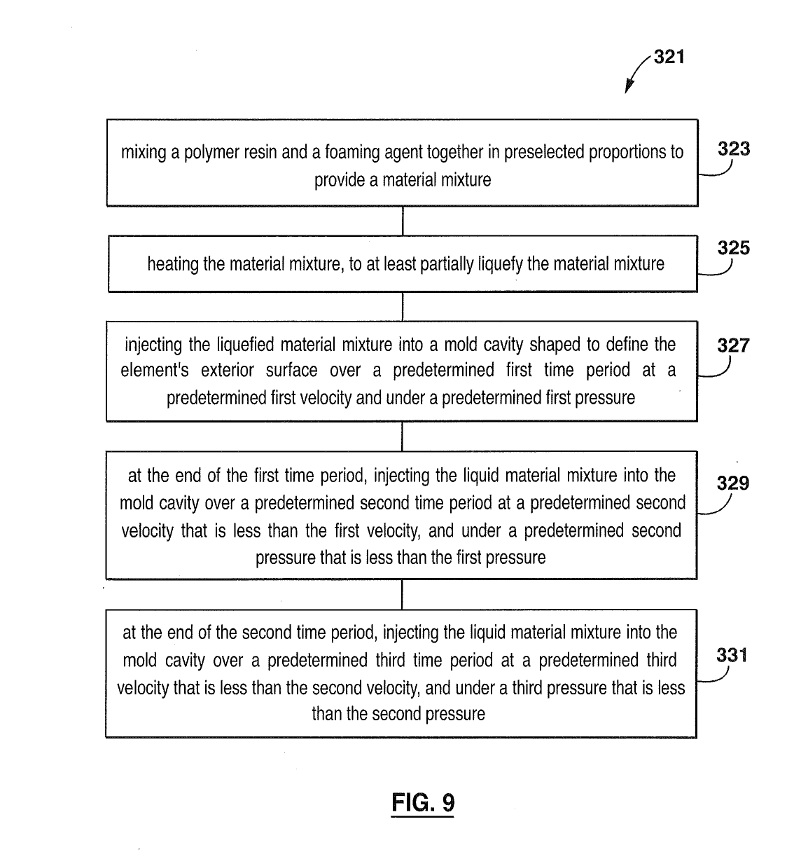

An embodiment of a method 321 of the invention is schematically illustrated in FIG. 9. The method is for forming one or more elements 122 to float at least partially on the surface 119 of the at least partially liquid hydrocarbon mixture 112. The method 321 preferably begins with mixing a polymer resin and a foaming agent together in preselected proportions to provide a material mixture (FIG. 9, step 323). The material mixture is heated, to at least partially liquefy the material mixture (step 325). Preferably, the at least partially liquefied material mixture is injected into a mold cavity configured to define the element's exterior surface over a predetermined first time period at a predetermined first velocity and under a predetermined first pressure (step 327). At the end of the predetermined first time period, the at least partially liquefied material mixture is injected into the mold cavity over a predetermined second time period at a predetermined second velocity that is less than the first velocity, and under a predetermined second pressure that is less than the first pressure (step 329). At the end of the second time period, the at least partially liquefied material mixture is injected into the mold cavity over a predetermined third time period at a predetermined third velocity that is less than the second velocity, and under a third pressure that is less than the second pressure (step 331).

As described above, it has been determined that polypropylene, HDPE, and PE are not suitable materials for use with the hydrocarbon mixture. It has been determined that a polyamide polymer is suitable. Accordingly, and as noted above, in one embodiment, the polymer resin preferably is a polyamide. Preferably, the polyamide polymer resin is Nylon 612.

As noted above, the specific gravity of Nylon 612 is approximately 1.07 and the specific gravity of the heavy crude oil is about 0.92. In order for the element 122 to be positioned as preferred when floating partly in and on the mixture 112, the specific gravity of the element 122 may be approximately 50 to 60 percent of the specific gravity of the mixture 112, i.e., before adsorption/absorption of any of the liquid hydrocarbon into the element 122. That is, the element's specific gravity preferably is approximately 0.46 or less, representing a decrease in density of the Nylon 612 of approximately 57 percent, or more. This large density reduction has been achieved using the method of the invention.

This is a surprising and unusual result, because it is generally understood that a density reduction of 30 percent is the most that can typically be achieved when utilizing standard injection molding equipment.

To practise the invention herein, standard injection molding equipment is used to inject the material mixture, as noted above. Those skilled in the art would appreciate that, in the typical injection molding machine, the heated resin (i.e., the material mixture) is pushed through the barrel 166 by a plunger 168, e.g., driven by a screw or a ram device (not shown). During an injection, the plunger travels from a first end 170 to a second end 172 (FIG. 7C). The second end 172 is in fluid communication with the mold cavity 160 and via a nozzle 174. (It will be understood that the material mixture and many components of the injection molding machine are omitted from FIG. 7C for clarity.)

The plunger 168, in moving from the first end 170 to the second end 172, injects the molten material mixture into the mold cavity 160 via the nozzle 174. When the plunger 168 arrives at the second end 172, the injection is completed, and substantially all the material mixture that was in the barrel 166 has been injected into the mold cavity 160. As described above, in the tooling (i.e., the mold assembly 154) used with the method of the invention, the only unusual features are the larger number of vents, and also the oversized vents.

Those skilled in the art would be aware that, in the prior art, the movement of the plunger from the first end to the second end is considered the first of two stages. In the second stage, the material injected into the mold cavity is “held” for a certain period of time. In the prior art, injection molding only involves these two stages.

In order to achieve the unusually large density reduction referred to above, the method of the invention involves a number of unusual steps and features. For instance, in one embodiment, it is preferred that the foaming agent makes up more than 1 percent by weight of the material mixture, the balance being the polymer resin. It is preferred that the foaming agent comprises approximately 1.3 percent by weight of the material mixture. This is an unusually high concentration of foaming agent, as the maximum typically recommended is 1 percent. In order to ensure accuracy, it is preferred that a continuous loss-in, weigh system (utilizing dual load cells) is used. Those skilled in the art would be aware of suitable weighing and control systems.

As described above, it has been determined that the unusually large decrease in density is achievable when the material mixture is injected into the mold cavity in at least three steps. As noted above, in the first step, the material mixture is injected over the predetermined first time period, at the predetermined first velocity, and under the predetermined first pressure.

Those skilled in the art would be aware that the amount of time required for injection molding of a particular part depends, among other things, on the size (i.e., mass) of the part to be formed. For example, if the element 122 has a mass of approximately 286 grams (approximately 0.63 lbs.), then the total injection time is approximately 4.5 seconds.

Accordingly, it is believed that the predetermined time periods are most appropriately expressed herein in terms of the position of the plunger 168 in the barrel 166 during the process. For instance, in one embodiment, it is preferred that the first predetermined time period terminates when the plunger 168 is approximately at a halfway point (identified by reference numeral 176 in FIG. 7C) along the barrel 166, i.e., approximately halfway between the first and second ends 170, 172 of the barrel 166. In one embodiment, therefore, the first predetermined time period is the time in which the plunger 168 travels in the direction indicated by arrow “X₁” in FIG. 7C from the first end 170 of the barrel 166 to the halfway point 176 on the barrel 166, the halfway point 176 being approximately equidistant between the first and second ends 170, 172 of the barrel 166.

At the end of the first step, the second step begins. There is no time delay between the first and second steps. As noted above, the second step involves injecting the material mixture over the predetermined second time period, at the predetermined second velocity, and under the predetermined second pressure. The second predetermined time period is the time in which the plunger 168 travels in the direction indicated by arrow “X₂” in FIG. 7C from the halfway point 176 to a location 178 that is approximately equidistant between the halfway point 176 and the second end 172. The second predetermined time period preferably terminates when the plunger reaches the location 178.

It will be understood that only one plunger 168 is located in the barrel 166. The plunger 168 is shown in dashed lines at two locations in FIG. 7C to indicate its movement.

Those skilled in the art would be aware of a suitable maximum velocity of injected material in a conventional injection molding machine. For example, a typical maximum velocity is approximately 240 mm/second (approximately 0.79 feet/second). Also, those skilled in the art would be aware of a suitable maximum pressure to which the injected material may be subjected. For instance, in one embodiment, the predetermined first pressure is approximately 21,000 psi (approximately 0.07 kg-force per square cm).

It is preferred that the second velocity is approximately 50 percent of the first velocity, and the second pressure is approximately 48 percent of the first pressure.

Once the second step is completed, the third step commences. There is no time delay between the second and third steps. The third step involves injecting the material mixture into the mold cavity 160 over the predetermined third time period. In accordance with the foregoing, in one embodiment, the predetermined third time period preferably is the time required for the plunger to move in the direction indicated by arrow “X₃” in FIG. 7C from the aforesaid location 178 in the barrel 166 to the second end 172 of the barrel 166. It is also preferred that the third velocity is approximately 50 percent of the second velocity, and the third pressure is approximately 75 percent of the second pressure. From the foregoing, it can be seen that the decreases in the velocity preferably are linear, however, the decreases in pressure preferably are not linear.

It will be understood that the material mixture (not shown in FIG. 7C) is injected into the mold cavity 160 in the mold assembly or tooling 154 via the nozzle 174 in the direction indicated by arrow “Y” in FIG. 7C.

By way of example, when the element 122 has a mass of approximately 286 grams (approximately 0.63 lbs.), in one embodiment, the first predetermined time period preferably is approximately 1.0 second, the second predetermined time period is approximately 1.5 second, and the third predetermined time period is approximately 2.0 seconds. Where the barrel extends 216 mm (approximately 8.5 inches), the halfway point 176 is at approximately 108 mm (approximately 4.25 inches) from the first end, and the location 178 is at approximately 54 mm (approximately 2.1 inches) from the second end 172. Where the element is 286 grams (approximately 0.63 lbs.), it has been found that, by the end of the first predetermined time period, 142 grams (approximately 0.31 lbs.) have been injected; by the end of the second predetermined time period, approximately 212 grams (approximately 0.47 lbs.) in total have been injected; and in the third predetermined time period, another approximately 74 grams (approximately 0.16 lbs.) are injected, i.e., for a total of approximately 286 grams (approximately 0.63 lbs.).

From the foregoing, it can also be seen that the method of the invention does not include a “hold” or “pack” stage that typically is a second stage in a conventional injection molding process, the first stage being injection. It has been found that, in the method of the invention, no hold stage is needed. Instead, the injection proceeds from the first step to the second step, and then from the second step to the third step, without stopping. Accordingly, the method of the invention differs significantly from the prior art method.

It has also been determined that the temperature of the material mixture preferably is about 30° F. (approximately 1.1° C.) lower than the usual temperature for polyamide polymers, e.g., about 470° F. (approximately 243.3° C.) at the nozzle, and otherwise about 450° F. (approximately 232.2° C.). Accordingly, in one embodiment, the temperature of the material mixture during the predetermined first, second, and third time periods is approximately 450° F. (approximately 232.2° C.). Those skilled in the art would appreciate that such a reduction in barrel temperature is unusual. In the method of the invention, however, it has been found to be advantageous so that the melt flow of the resin is reduced to a level that is more conducive to the foaming process.

It is also preferred that a mechanical shut-off tip serves as the gateway from the barrel of the injection molding machine to the injection mold assembly 154. The shut-off tip prevents pressure from the barrel of the machine from “choking” off the expansion in the mold cavity.

It has been found that, utilizing the method of the invention, the element 122 formed according thereto preferably has a specific gravity of between approximately 0.42 and approximately 0.49. Preferably, the specific gravity of the element 122 formed according to the method of the invention is 0.46 or less.

As described above, the very large reduction in density of the polyamide polymer resin is achieved by adopting an unusual process. In addition, the element 122 formed using the method of the invention has a substantially uniform cellular structure internally, which is advantageous for the reasons set out above. An unexpected benefit of employing the method of the invention is that it results in the elements 122 having unusually good anti-static characteristics. The reasons for this phenomenon are not well understood at this time. However, it is an important benefit, because it means that no additives or treatments are needed in order for the elements 122 to have the desired anti-static surface characteristics.

It would be appreciated by those skilled in the art that, for safety, the element preferably has anti-static characteristics, i.e., its surface preferably is somewhat conductive, to discourage a build-up of an electrostatic charge thereon. In one embodiment, the element 122 formed according to the method of the invention has a surface resistivity less than approximately 1×10¹² Ohms. In another embodiment, the element 122 preferably has a surface resistivity of approximately 9.03×10¹⁰ Ohms. Because a surface resistivity less than 1×10¹² Ohms is considered to provide good anti-static characteristics, the element 122 is believed to have relatively good anti-static characteristics.

It has been found that, in the absence of the elements 122, the mixture (i.e., the heavy crude oil) has sufficient conductivity that static electricity is generally not an issue in the collection tank. The conductivity of the mixture and/or the heavy crude oil is generally due to the presence of water ions, dissolved salts, and heavy metals therein. However, when the elements 122 are initially introduced into the container or collection tank 110, they may have static electricity charges accumulated thereon. (At that point, the elements are not covered by the mixture and/or crude oil.) Upon introduction of the elements into the container, therefore, static electricity may otherwise be potentially dangerous (i.e., if the elements did not have good anti-static characteristics), as the static electricity charge could discharge and ignite petroleum fumes or crude oil inside the headspace “H” of the container. It is believed that there is less risk of static electricity build-up once the elements 122 become at least partially covered by the mixture and/or the heavy crude oil, and their anti-static properties become less important, because the mixture and/or the heavy crude oil is relatively conductive.

It is also preferred that the system 120 includes a number of the elements 122 formed according to the method of the invention. Preferably, the elements 122 are engaged with each other (i.e., at the central plates of each), as described above, to substantially cover the surface 119 of the mixture 112, for impeding transfer of thermal energy and also for impeding the emission of vapours from the mixture 112 via the surface 119. For example, and as can be seen in FIGS. 1B and 1C, the elements 122 preferably are positioned in the mixture 112 so that the central plate 134 is above the surface 119, and the outer edges 138 of the elements 122 preferably are engaged with each other across the surface 119 so that the transfer of thermal energy from the mixture to the atmosphere via the surface 119 is impeded or hindered. Also, the system 120 impedes or hinders the release of vapours from the mixture into the atmosphere via the surface 119. It will be understood that the transfer of thermal energy from the mixture to the atmosphere, and the release of vapours from the mixture to the atmosphere, are not completely stopped by the system.

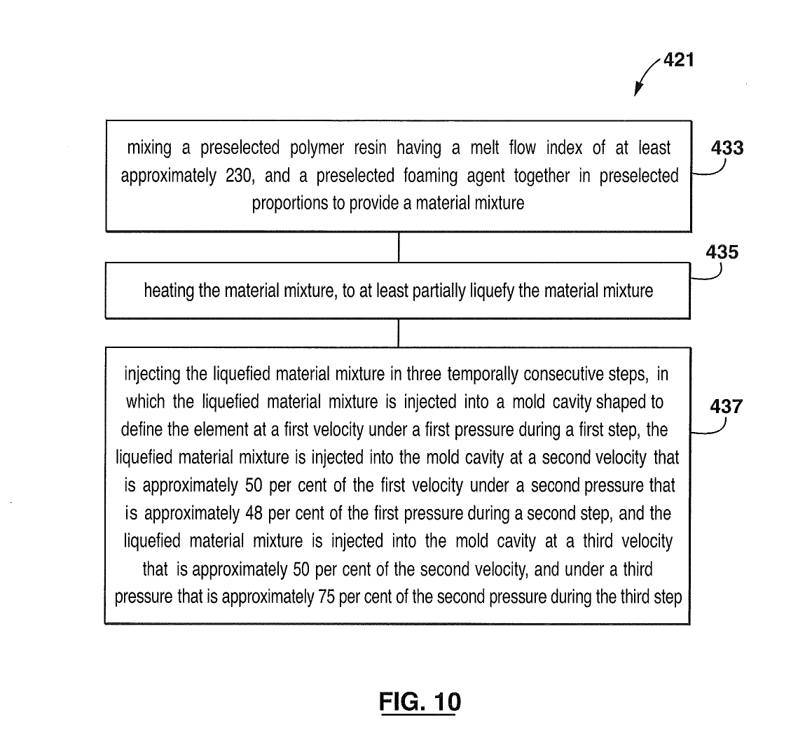

Another embodiment of the method 421 of the invention is schematically illustrated in FIG. 10. The method 421 is for forming one or more elements 122, to float at least partially on the surface 119 of the at least partially liquid hydrocarbon mixture 112. Preferably, the method includes, first, mixing a preselected polymer resin having a melt flow index of at least approximately 15, and a preselected foaming agent together in preselected proportions to provide the material mixture (FIG. 10, step 433). Preferably, the material mixture is heated, to at least partially liquefy the material mixture (step 435). The at least partially liquefied material mixture is injected in three temporally consecutive steps, in which the at least partially liquefied material mixture is injected into a mold cavity configured to define the element at a first velocity under a first pressure during a first step, the at least partially liquefied material mixture is injected into the mold cavity at a second velocity that is approximately 50 percent of the first velocity under a second pressure that is approximately 48 percent of the first pressure during a second step, and the at least partially liquefied material mixture is injected into the mold cavity at a third velocity that is approximately 50 percent of the second velocity, and under a third pressure that is approximately 75 percent of the second pressure during the third step (step 437).

It will be understood that, in the foregoing method 421, it is preferred that the foaming agent makes up more than 1 percent of the material mixture by weight, the balance being the polyamide polymer resin. It will also be understood that the polyamide polymer resin preferably is Nylon 612.

The temperatures of the material mixture in the method 421 are the same as the corresponding temperatures described above in connection with the method 321. Also, it will be understood that the duration of each of the first, second, and third steps preferably is determined according to the position of the plunger in the barrel during injection, as described above.

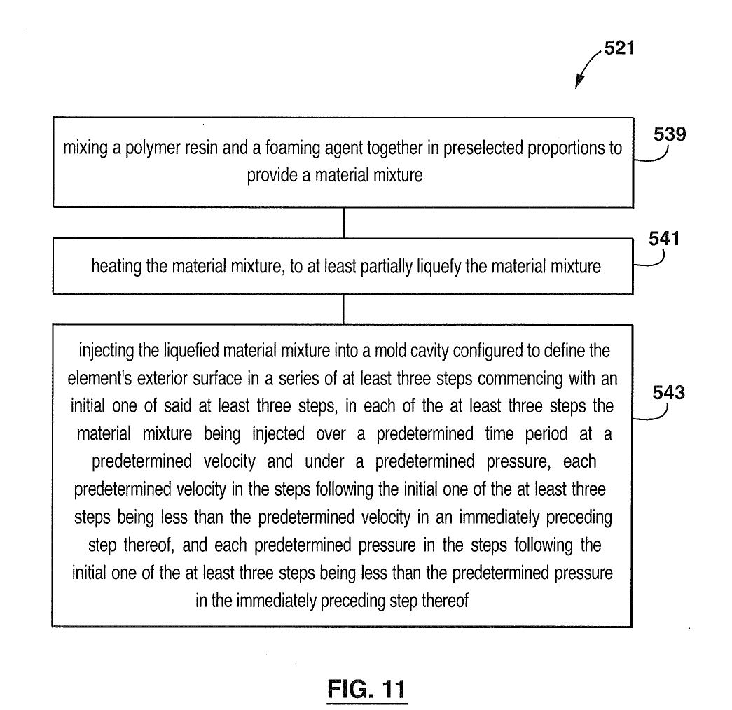

Another embodiment of the method 521 of the invention is schematically illustrated in FIG. 11. The method 521 is for forming one or more elements 122. Preferably, the method includes, first, mixing a polymer resin and a foaming agent together in preselected proportions to provide a material mixture (FIG. 11, step 539). The material mixture is heated, to at least partially liquefy the material mixture (step 541). The at least partially liquefied material mixture is injected into the mold cavity configured to define the element's exterior surface in a series of at least three steps commencing with an initial one of the at least three steps. In each of the at least three steps, the material mixture is injected into the mold cavity over a predetermined time period at a predetermined velocity and under a predetermined pressure. Each predetermined velocity, in the steps following the initial one of the at least three steps, is less than the predetermined velocity in an immediately preceding step thereof. Also, each predetermined pressure, in the steps following the initial one of the at least three steps, is less than the predetermined pressure in the immediately preceding step thereof (step 543). Those skilled in the art would appreciate that, depending on the circumstances, additional steps (i.e., more than three) may be utilized, depending on the results that are sought to be achieved and a number of other variables, including the desired specific gravity of the element formed using the method.

As noted above, the method of the invention achieves surprising results, in view of the prior art. The method does not include a “hold” or “pack” stage, typically included in known injection molding methods. The density of the polymer resin is reduced by approximately 60 percent, which far exceeds density reductions that can typically be achieved. Also, the element formed in the method of the invention has a surprisingly low surface resistivity, so that its anti-static characteristics are relatively good. The elements 122 produced according to the method of the invention may be positioned in the container 110 to form the system 120, in which the elements 122 engage each other to substantially cover the entire surface 119, to impede transfer of thermal energy from the mixture 112 via the surface 119, and to impede release of vapours from the mixture via the surface 119.

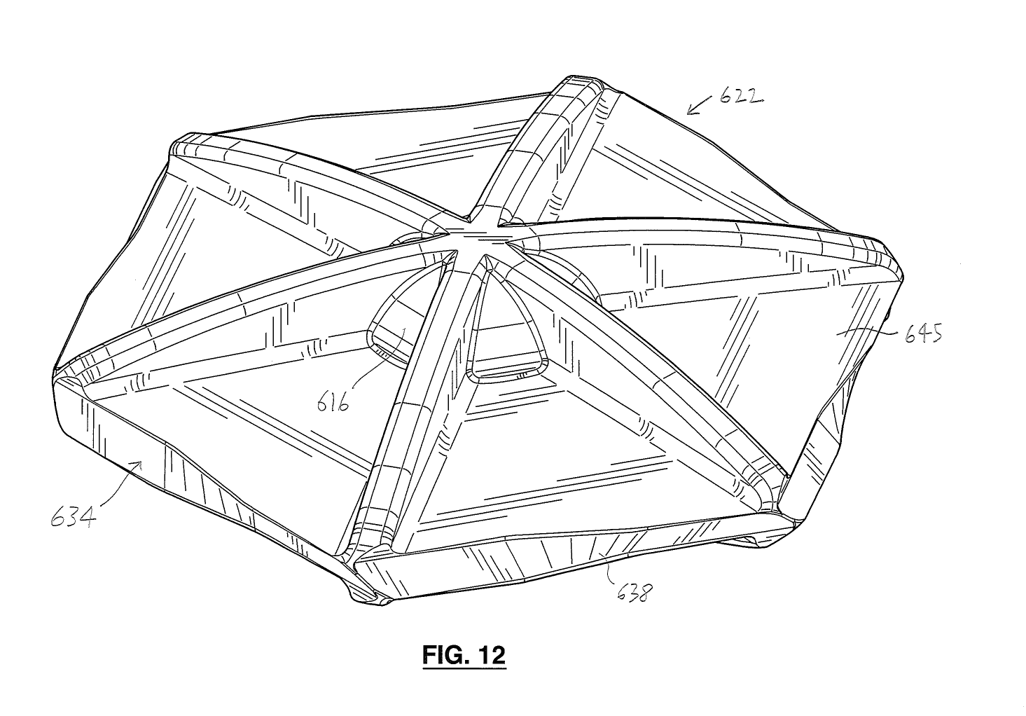

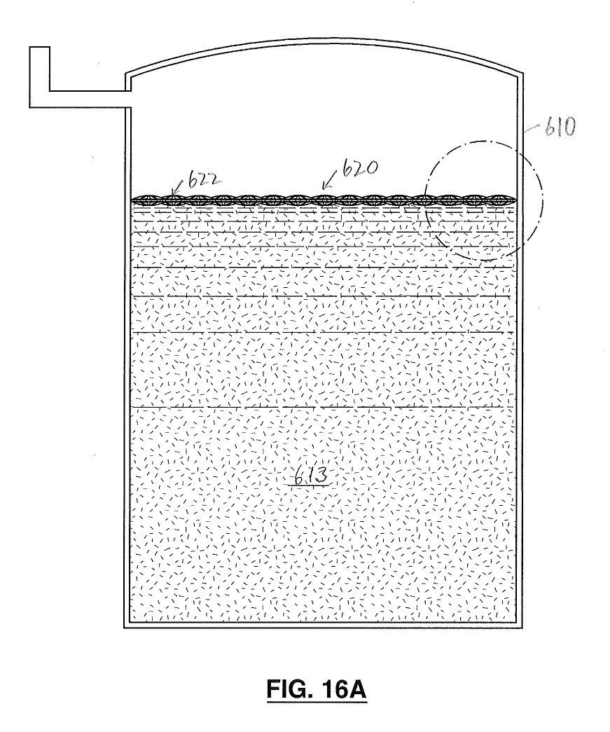

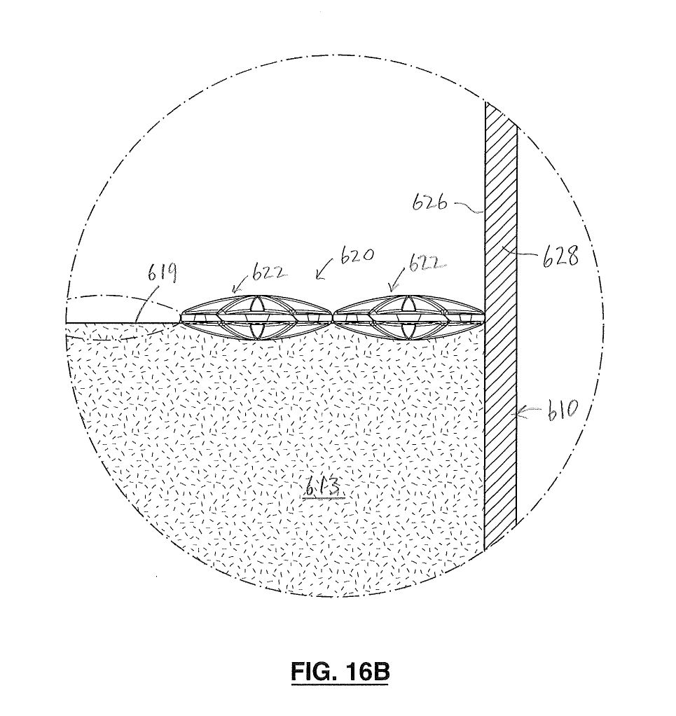

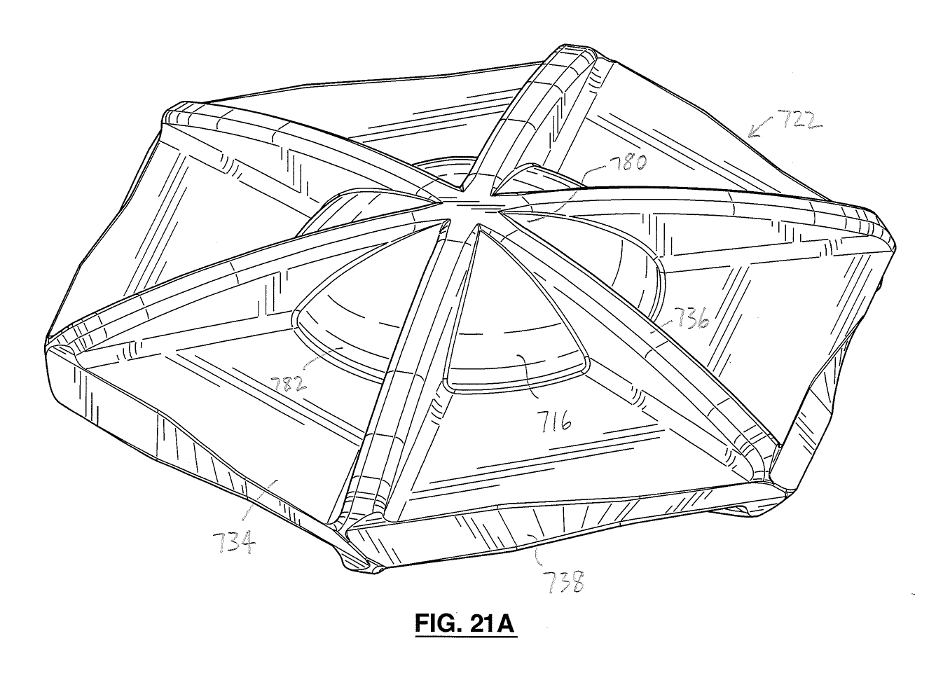

Reference is made to FIGS. 12-22 to describe additional alternative embodiments of the system and the method of the invention. In one embodiment, a method of the invention is for forming one or more elements 622 to have a preselected element density, for floating at least partially on a surface 619 of an at least partially liquid hydrocarbon mixture 613 (FIGS. 16A-18) having a known liquid density. Preferably, the method includes the step of, first, determining the preselected element density based on the known liquid density. As will be described, it is preferred that the preselected element density is not greater than a predetermined proportion of the known liquid density. In one embodiment, the preselected element density preferably is much less than the known liquid density. Preferably, a mold cavity 660 is provided (FIG. 20) that is formed to define an exterior surface 645 (FIG. 12) of the element 622 with an exterior surface area. The exterior surface area 645 preferably is formed to result in the element 622 having the preselected density, as will also be described.

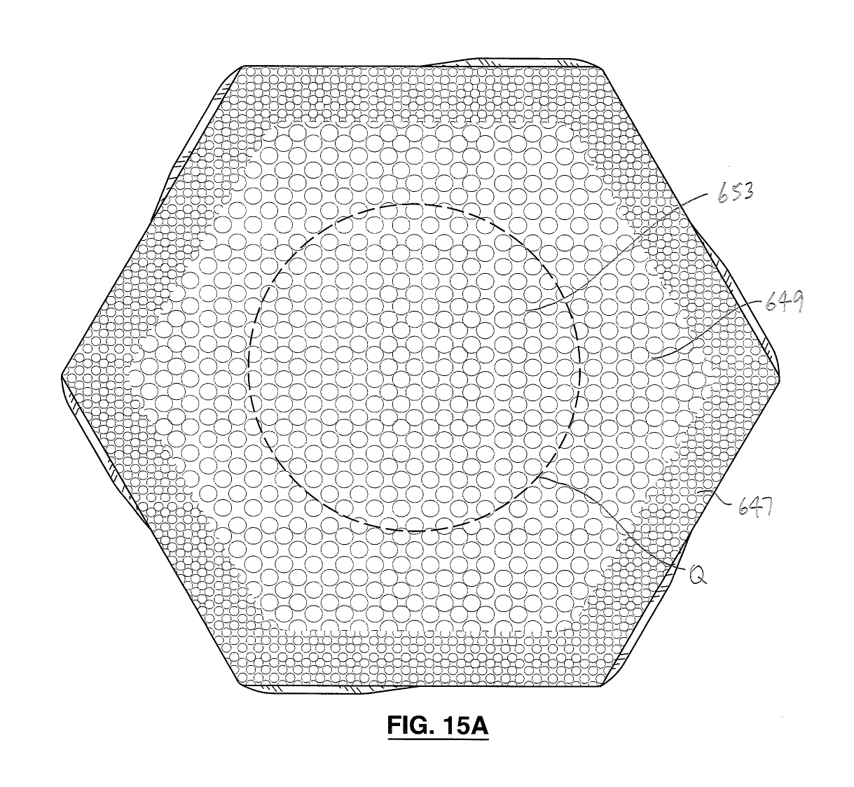

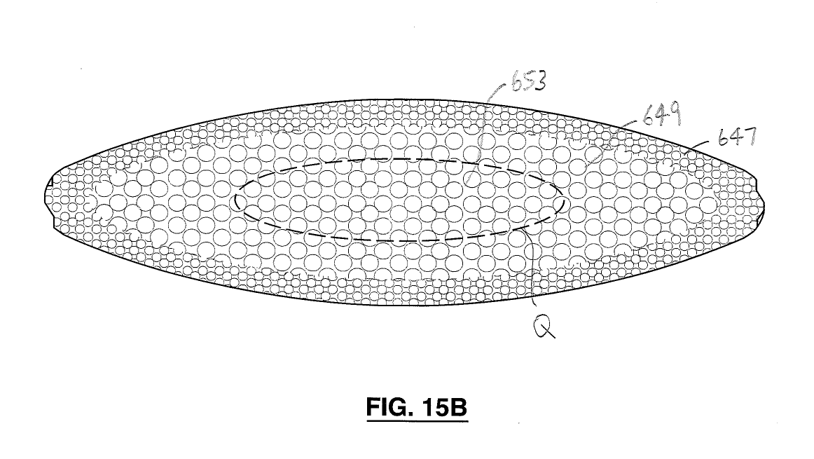

Preferably, a polymer resin and a foaming agent are mixed together in preselected proportions to provide a material mixture. The material mixture is heated, to at least partially liquefy the material mixture. The at least partially liquefied material mixture preferably is then injected into the mold cavity 660 over a predetermined first time period at a predetermined first velocity and under a predetermined first pressure. This step provides a first layer 647 of first material (FIGS. 15A, 15B) that at least partially forms the exterior surface 645 of the element 622, as described further below. The first layer 647 is relatively fine-grained, and also relatively dense. At the end of the first predetermined time period, the at least partially liquefied material mixture is injected into the mold cavity 660 over a predetermined second time period at a predetermined second velocity that is less than the first velocity, and under a predetermined second pressure that is less than the first pressure, to provide a second layer 649 of second material (FIGS. 15A, 15B) on the first material that is less dense than the first material. At the end of the second predetermined time period, the at least partially liquefied material mixture is injected into the mold cavity 660 over a predetermined third time period at a predetermined third velocity that is less than the second velocity, and under a third pressure that is less than the second pressure to provide a third layer 653 of third material (FIGS. 15A, 15B) that is also less dense than the first material.

Once the material mixture has cooled, the layers each include a number of cells. It will be understood that, in FIGS. 15A and 15B, the first layer 647 is schematically represented by a layer of relatively smaller cells, packed together. The third layer 653 is a central area of larger cells that are illustrated as being less dense. The boundary between the third and second layers 653, 649 is schematically represented by a dashed line “Q” in each of FIGS. 15A and 15B.

It will be understood that the liquid hydrocarbons 613 (i.e., the liquid hydrocarbon mixture) may include lighter hydrocarbons, i.e., the liquid hydrocarbons 613 may be any one of conventional light oil; conventional medium-heavy oil; conventional heavy oil; bitumen; diluted bitumen (dilbit); and diluents. Among the “lightest” of these probably would be diluent. As noted above, an example of a diluent is pentane, with a specific gravity of 0.626.

As noted above, one embodiment of the element 122 is formed for floating on heavy crude oil having a density of approximately 0.92 g/cc (about 57.4 lb./cu. ft.). The element 122 preferably has a minimum density of approximately 0.42 g/cc, i.e., when it is first formed, before the element 122 is positioned on the liquid hydrocarbons.

However, it is desirable to form the element of the invention with a density sufficiently low that it could be used with lighter hydrocarbons, e.g., pentane (specific gravity of 0.626). As described above, in order for the element 622 to be feasible for use with liquid hydrocarbons 613 that are the less dense hydrocarbons, the density of the element 622 preferably is less than 0.42 g/cc. In one embodiment, the element 622 of the invention has been formed with a density of approximately 0.41 g/cc (about 25 lbs./cu. ft.), which is satisfactory for some lighter hydrocarbons, as will be described. As noted above, it has been found that the lower density is achievable by reducing the surface area of the element 622 by an appropriate extent.

The reduction in surface area of the element results in the first layer 647 forming a smaller proportion of the mass of the element. Because the first layer is more dense than the second and third layers, reducing the proportion of the element's mass that is the first layer results in the element's density being correspondingly less.

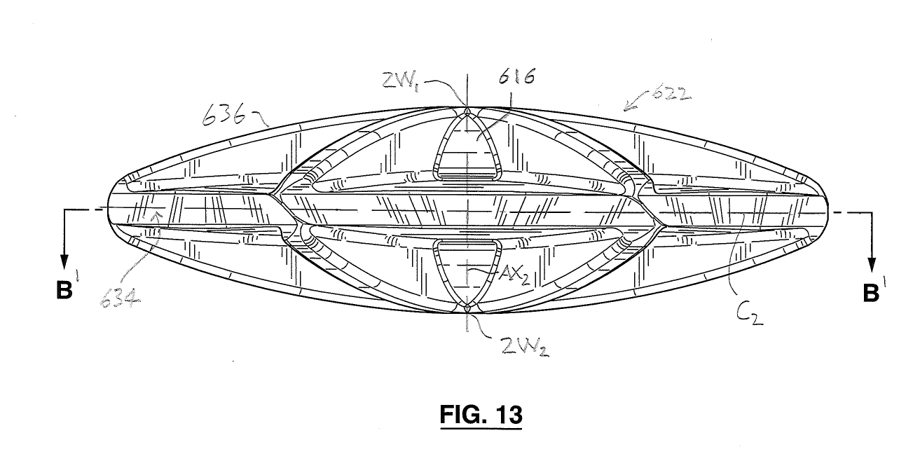

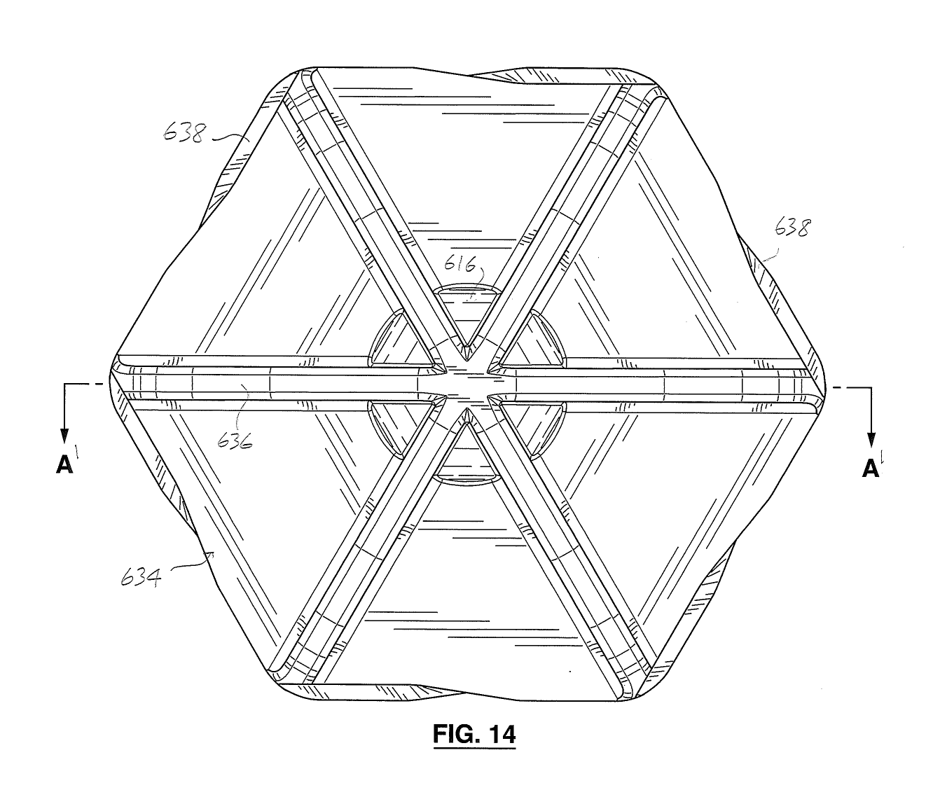

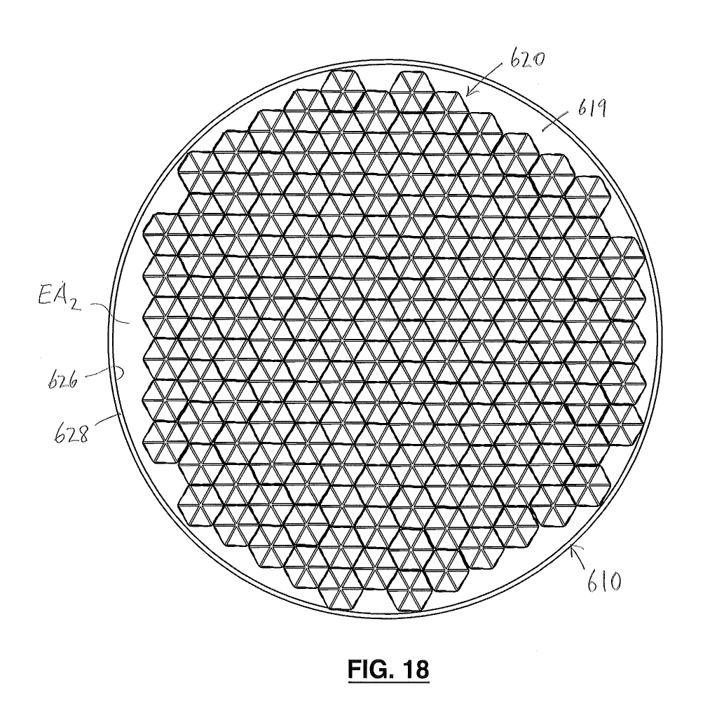

As can be seen in FIGS. 12-14, in one embodiment, the element 622 preferably includes a central plate 634 and a central part 616 located in the center of the central plate 634, symmetrically formed relative to a central axis “AX₂” thereof (FIG. 13). It is also preferred that the element 622 includes six outward faces 638, arranged to substantially define a hexagonal outline of the element 622, when the element 622 is viewed in plan view (FIG. 14). Also, the element 622 preferably includes ribs or ridges 636 extending between the outward faces 638 and the central axis “AX₂” (FIG. 13). Preferably, the ribs 636 are formed so that the elements 622 will, when positioned on top of each other in a tank 610 with liquid hydrocarbons 613 in it, slide apart to fall onto and to float on the liquid hydrocarbons (FIG. 16B). It is preferred that a sufficient number of the elements 622 are used for a particular tank, so that they substantially cover the surface 619 of the liquid hydrocarbons 613 in the tank 610 (FIG. 18).

A system 620 of the invention preferably includes a number of the elements 622 (FIGS. 16A, 16B). The positioning of the elements 622 adjacent to each other on the liquid hydrocarbons 613 can be seen in FIGS. 16A and 16B. Preferably, and as illustrated in FIGS. 16A and 16B, a sufficient number of the elements 622 are positioned in the tank 610 to cover, or substantially cover, the surface 619 of the liquid hydrocarbons 613. Ideally, the elements 622 engage each other at their respective outward faces 638 and also engage the interior surface 626 of tank wall(s) 628 (FIG. 16B). Depending on the area of the surface 619, and as can be seen in FIG. 18, the system 620 may not cover the entire surface 619 of the liquid hydrocarbons 613. In FIG. 18, for example, the system 620 defines a small part “EA₂” of the surface 619 that is not covered. Those skilled in the art would appreciate that, where the area of the surface 619 is larger, the proportion thereof that is left uncovered by the system 620 is correspondingly smaller.

As noted above, the first layer of material 647 is more dense than the other layers 649, 653 of solidified material included in the element 622 (FIGS. 15A, 15B). Accordingly, in one embodiment, in order to provide the element with a suitable preselected element density, proportionately less of the first layer of material 647 preferably is included in the element 622. However, as will be described, reducing the thickness of the first layer (i.e., the quantity of the first layer relative to the second and third layers) may limit the useful life of the element.

Because of this, reducing the proportion of the element that is the first layer 647 preferably is achieved by reducing the surface area of the element 622 accordingly, thereby reducing the proportion of the total mass of the element 622 that is made up of the first layer 647, as compared, for example, to the surface area of the embodiment of the element 122 illustrated in FIGS. 1A and 1B.

As can be seen in FIGS. 12-14, in one embodiment the surface area of the floating element 622 preferably is reduced (relative to the surface area of the element 122) by increasing the thickness of the ribs 636. Also, the element 622 preferably has a lower profile, and this also results in less surface area. For instance, as illustrated in FIG. 13, the ribs 636 converge at points “2W₁” and “2W₂” that are located at top and bottom ends of the central part 616. That is, at the points “2W₁” and “2W₂” where the ribs 636 converge, the ribs 636 are engaged with the central part 616. As can be seen by comparing FIG. 13 and FIG. 2A, in one embodiment, the element 622 preferably has a lower profile or height (i.e., relative to the central part 616) than the element 122. It can be seen in FIG. 13 that, in the embodiment of the element 622 illustrated therein, there is virtually no gap discernible between the ridges 636 at their points of convergence “2W₁”, “2W₂” and the central part 616. In addition, in the element 622, each of the ribs 636 is wider than the ribs 136 in the embodiment of the element 122, described above (FIGS. 11A, 11B).

Another advantage of the thicker ribs 636 is that they are more robust than the thinner ribs of the embodiment of the element 122.

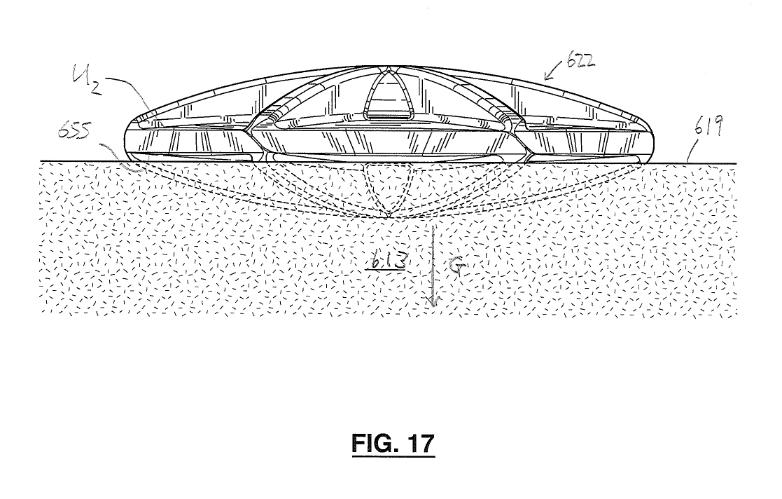

An example of the desired initial position of the element 622 on the surface 619 of the liquid hydrocarbons 613 can be seen in FIG. 17. When the element 622 is first positioned in and on the liquid hydrocarbons 613, the element 622 floats with only a relatively small portion thereof submerged in the liquid hydrocarbons. At this point, it is preferred that the central plate 634 is located above the surface 619. It is preferred that a surface 655 of the central plate 634 that is facing downwardly is positioned slightly above the liquid hydrocarbons' surface 619, when the element 622 is first positioned in and on the liquid hydrocarbons 613. The central plate 634 has an upper surface “U₂” that is opposite to the surface 655 of the central plate 634 (FIG. 17). As can be seen in FIG. 17, when the element 622 is first positioned in the liquid hydrocarbons 613, it is preferred that the upper surface “U₂” is positioned above the surface 619. As described above, due to the migration, i.e., adsorption and/or absorption, of liquid hydrocarbons into the element 622 over time as it is partially immersed in the liquid hydrocarbons 613, the element 622 becomes more dense over time, and its position relative to the surface 619 will gradually lower, i.e., the element's position 622 relative to the surface 619 will gradually move in the direction indicated by arrow “G” in FIG. 17.

Once the upwardly facing surface “U₂” of the central plate 634 is at least partially at the same level as the surface 619, the element 622 should be removed, and replaced by a new element 622. This is because, once the liquid hydrocarbons 613 are covering at least part of the upwardly facing surface “U₂” of the central plate 634, the element 622 is no longer covering the liquid hydrocarbons 613, and is generally unable to prevent the escape of VOCs. At that point, accordingly, the element's useful life has concluded.

As an example, and referring to FIGS. 12-14, each of the ribs 636 has a width of up to approximately 0.612 inches (about 1.55 cm). The central plate 634 preferably has a thickness of approximately 0.60 inches (about 1.524 cm), and the overall height of the element 622 is approximately 2.78 inches (about 7.07 cm). In one embodiment, the element 622 preferably has an overall width of approximately 8.80 inches (about 22.35 cm).

As noted above, the density of the element 622 has been found to be less than that of the embodiment of the element 122 described above, due to the element 622 having relatively less surface area. In one embodiment, for example, the density of the floating element 622 preferably is approximately 0.41 g/cc (approximately 25 lbs./cu. ft.).

It has been determined that the element 622 has an electrostatic discharge characteristic (i.e., surface resistivity) of approximately 3.3×10⁹ Ohms per square, which means that the element is considered to have antistatic properties. Those skilled in the art would appreciate that this is a significant characteristic, as it indicates that introducing a number of the elements 622 is unlikely to cause dangerous static discharge inside the tank.

It is preferred that the polymer resin is a polyamide. Preferably, the polyamide polymer resin is Nylon 612. It is also preferred that the foaming agent includes more than 1 percent of the material mixture by weight, the balance being the polymer resin. Those skilled in the art would be aware of suitable foaming agents.

In summary, and as can be seen in FIG. 13, the element 622 includes the central plate 634 partially defined by a central plane “C₂”, and the at least partially spherical central part 616 centrally located on the central plate 634. The central part 616 is at least partially defined by the central axis “AX₂” thereof positioned orthogonal to the central plane “C₂” (FIG. 13). A number of the ribs converge at points “ZW₁”, “ZW₂” on opposite sides of the central part 616 that are aligned with the central axis “AX₂”.

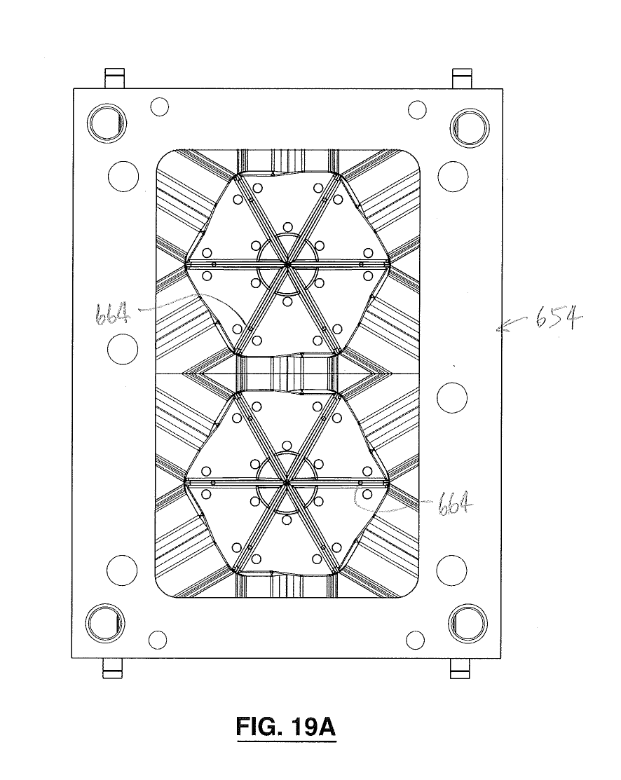

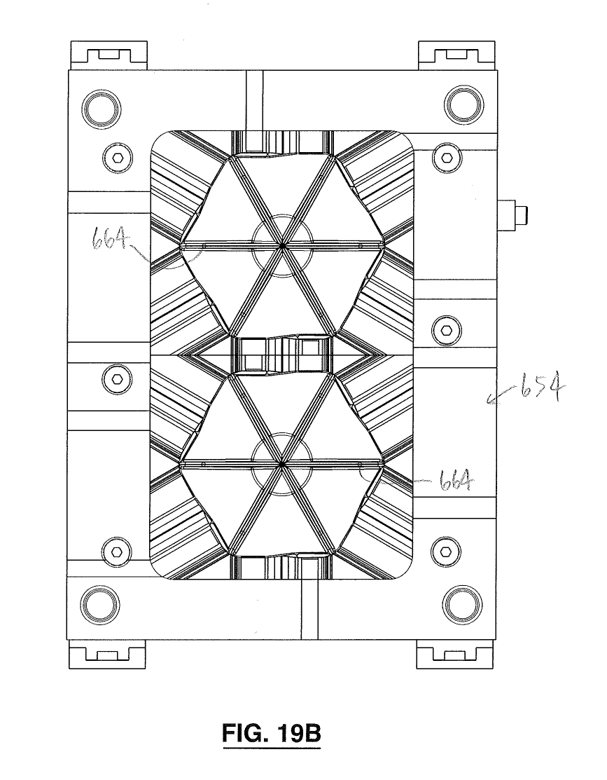

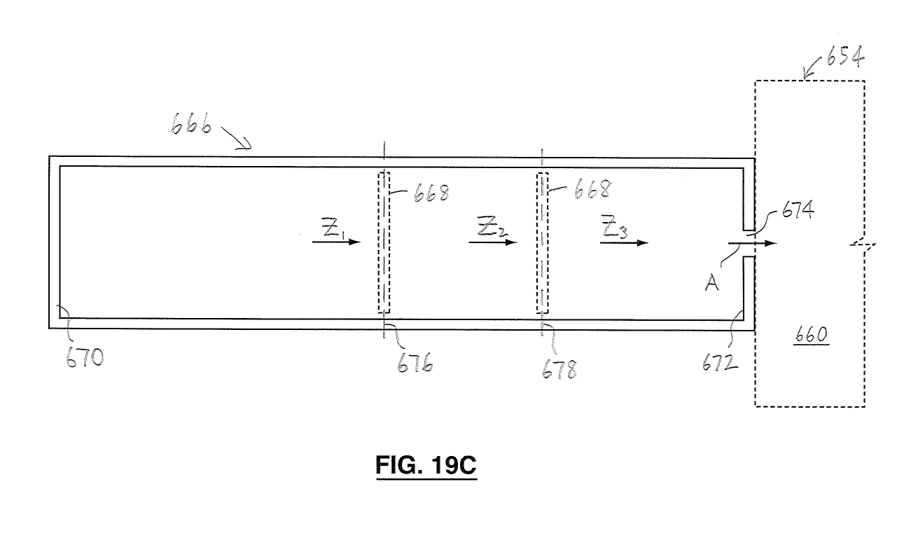

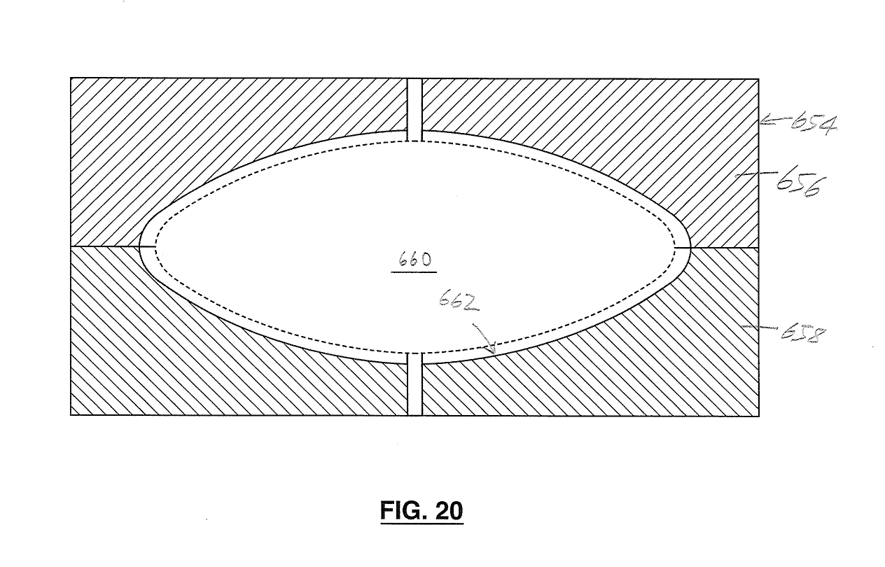

In order to form the element 622, one or more mold assemblies (i.e., tooling) 654 are used (FIGS. 19A, 19B). Preferably, a conventional injection molding machine (not shown) is used to inject the material mixture (as defined above) into the mold assembly 654. The mold assembly 654 preferably includes first and second parts 656, 658 that are joined together to define one or more of the mold cavities 660 therein, as shown in FIG. 20. It will be understood that the first and second parts 656, 658 as illustrated each include one half of a mold 662 defining the mold cavity 660.

In one embodiment, the element 622 is formed by the method including mixing the polymer resin and the foaming agent together in preselected proportions to provide the material mixture, and heating the material mixture, to at least partially liquefy the material mixture. The mold cavity, configured to form the element is provided. The element includes the central plate partially defined by the central plane, the at least partially spherical central part centrally located on the central plate, the central part being at least partially defined by the central axis “AX₂” thereof positioned orthogonal to the central plane, and the ribs converging at respective points “ZW₁”, ZW₂″ on opposite sides of the central part that are aligned with the central axis. The at least partially liquefied material mixture is injected into the mold cavity over a predetermined first time period at a predetermined first velocity and under a predetermined first pressure to form the first layer of the material mixture defining the exterior surface of the element 622. At the end of the first predetermined time period, the at least partially liquefied material mixture is injected into the mold cavity over a predetermined second time period at a predetermined second velocity that is less than the first velocity, and under a predetermined second pressure that is less than the first pressure to form the second layer of the material mixture on the first layer. At the end of the second predetermined time period, the at least partially liquefied material mixture is injected into the mold cavity over a predetermined third time period at a predetermined third velocity that is less than the second velocity, and under a third pressure that is less than the second pressure to form a third layer of the material mixture on the second layer.

In one embodiment, the second velocity preferably is approximately 50 percent of the first velocity, and the second pressure is approximately 48 percent of the first pressure. It is also preferred that the third velocity is approximately 50 percent of the second velocity, and the third pressure is approximately 75 percent of the second pressure.

Preferably, the temperature of the material mixture during the predetermined first, second, and third time periods is approximately 450° F. (approximately 232.2° C.).

Vents 664 are provided, to allow gases released during the injection molding process to escape from the mold cavity 660 (FIGS. 19A-19C). However, in order to form the element 622 using the methods of the invention described herein, it has been found that certain of the vents 664 preferably are substantially larger than conventional vents. Also, there are larger additional vents provided in the mold assembly 654 of the invention.

For example, for an injection molded part made of a polyamide resin, 18 vents about 0.0005 inch (approximately 0.0013 cm) deep typically would be utilized. It is preferred that the mold assembly 654 includes the typical 18 vents. However, in addition to the aforesaid 18 vents, the mold assembly 654 may include another 12 vents, each measuring about 0.016 inch (approximately 0.04 cm) deep in the rib areas, and another 12 vents, measuring about 0.006 inch (approximately 0.015 cm) each on the parting line, and on about 0.008 inch (approximately 0.02 cm) deep on the center ball area. The additional, and unusually large, vents serve to regulate varying cavity pressures due to the complex geometry of the element 622 and facilitate the egress of gaseous byproducts generated during the chemical foaming process. For clarity, it will be understood that the vents are generally referred to by the reference numeral 664, regardless of whether the vents are “standard” or typical, or additional, and/or larger than typical vents.

Only the mold assembly 654 is shown in FIGS. 19A, 19B, and 20. A barrel 666 of a conventional injection molding machine is schematically illustrated in FIG. 19C, as will be described. It will be understood that the injection molding machine is conventional, except to the extent that it provides that three-stage injection process described herein.

As noted above, in one embodiment, it is preferred that the element 622 is made of a suitable polyamide polymer resin. It is also preferred that the polyamide resin is a suitable nylon, due to nylon's resistance to degradation when immersed in hydrocarbons. Preferably, the polyamide polymer resin is nylon 6, 12 (“Nylon 612”). As noted above, this resin is preferred because Nylon 612 tends not to degrade when in contact with the liquid hydrocarbon 613. Those skilled in the art would be aware of other resins that may be suitable for use in the liquid hydrocarbon 613.

However, because Nylon 612 has a specific gravity of approximately 1.07, and the liquid hydrocarbon 613 may have a specific gravity of approximately 0.92 or less, it is preferable that the density of the element 622 be as low as possible, subject to the limits noted above. (For example, as noted above, pentane has a specific gravity of 0.626.) As will be described, this preferably is achieved by, among other things, utilizing a foaming agent. The Nylon 612 resin and the foaming agent preferably are mixed together to form a material mixture, that is injected into the mold cavity. Due to the foaming agent and the process of injection molding, the material forming the element 622 preferably is in the form of a matrix of Nylon 612 around a number of voids, or bubbles. This structure is schematically illustrated in FIGS. 15A and 15B.

As noted above, the Nylon 612 resin has a melt flow (measured according to ASTM D1238) of approximately 15 or 16. It would be appreciated by those skilled in the art that a material with such a high melt flow tends to be relatively easily flowable, and consequently tends to be difficult to foam.

As noted above, it appears that, when the element 622 is floating in and on the liquid hydrocarbon 613, some of the liquid hydrocarbon 613 migrates or is adsorbed and/or absorbed into the element 622, over an extended period of time. At present, the mechanism of the migration of the liquid hydrocarbons 613 or part thereof into the element is not well understood. For the purposes hereof, “migration” or “adsorption/absorption” shall be understood to refer to adsorption or absorption, or both adsorption and absorption, or combinations thereof.

Reducing the surface area of the element as described herein has the additional benefit that it reduces the area of the element that may engage the liquid hydrocarbons, ultimately resulting in a relatively slower migration of the liquid hydrocarbons 613 into the element 622.

When in the system 620, each of the elements 622 is effective to minimize vapors escaping from the liquid hydrocarbons as long as the element maintains an elevation (relative to the surface of the liquid hydrocarbons) that is sufficient to prevent breaching of the central plate 634 by the liquid hydrocarbons. Preferably, the system 620 includes a sufficient number of the elements 622 to substantially (but not necessarily completely) cover the surface 619 of the liquid hydrocarbons 613 in the tank 610 (FIG. 18). As noted above, when the element 622 has adsorbed and/or absorbed sufficient liquid hydrocarbons that the upper surface “U₂” of the central plate 634 is substantially level with the surface 619 or lower, then the surface 619 is “breaching” the upper surface “U₂” of the central plate 634, and the element 622 preferably is replaced by a new element.

At this point, it is not known how long the element 622 of the invention may float in and on the liquid hydrocarbon 613 in a suitable position relative to the surface 619 (i.e., locating the central plate 634 above the liquid hydrocarbons 613, as described herein) before its density becomes too high, due to migration, or adsorption/absorption of the liquid hydrocarbon into the element 622. (To an extent, the useful life of the element 622 may also be affected by the type of liquid hydrocarbons in which it is partially immersed.) It is believed that the element 622 may continue to function acceptably, floating in the desired position relative to the surface 619 of the liquid hydrocarbon 613, over an extended period of time, e.g., several years.

As noted above, the first layer 647 includes relatively fine cells (i.e., the matrix of Nylon 612, with voids), and the first layer 647 surrounds the second and third layers 649, 653, which have coarser cellular structures (FIGS. 15A, 15B). In particular, it is preferred that the element 622 is formed so that a substantially uniform cell structure is provided in the first layer 647, and the second and third layer 649, 653 also have substantially uniform respective coarser cellular structures. This arrangement of cellular structures is thought to provide at least two barriers to migration or adsorption/absorption of the liquid hydrocarbon 613 into the element 622.

Initially, the liquid hydrocarbon 613 migrates, or is adsorbed/absorbed, into the finer cellular structure (i.e., the smaller voids) of the first layer 647. Those skilled in the art would appreciate that, due to the relatively fine structure, the adsorption/absorption of the liquid hydrocarbon 613 into the first layer 647 is likely to take some time. As compared to a coarser-grained structure, the migration of the liquid hydrocarbons in and through the finer-grained structure is likely to take longer because the finer-grained structure has relatively more cell walls per unit of length than the coarser-grained structure. This means that the migration of the liquid hydrocarbons into the finer-grained structure takes more time, as the liquid hydrocarbons are required to migrate through each wall of the finer-grained structure. A slower rate of migration of the liquid hydrocarbons into the element 622 results in a longer useful life thereof. Next, i.e., after the liquid hydrocarbon 613 is adsorbed/absorbed generally into the first layer 647, the liquid hydrocarbon 613 permeates into the coarser cells of the second layer 649 and the third layer 653 successively.

It will be understood that the respective cell structures of each of the first, second, and third layers 647, 649, 653 are respectively substantially uniform, although the sizes of the individual cells or voids differ, as described above. (It will be understood that in FIGS. 15A and 15B the matrix, and the voids therein, are schematically represented as being generally uniform in each respective layer 647, 649, 653 for clarity of illustration.) The internal structure of the element 622 as illustrated in FIGS. 15A and 15B is a schematic representation thereof. Because the respective cellular structures are substantially uniform, there are no relatively large internal openings, and the liquid hydrocarbon 613 is only able to infiltrate or permeate the element 622 one cell or void at a time. In this way, the substantially uniform cellular structures in the first, second, and third layers 647, 649, 653 are believed to significantly delay the adsorption/absorption of the liquid hydrocarbon 613 into the element 622.

In summary, one embodiment of a method of forming the element of the invention includes mixing the polymer resin and the foaming agent together in preselected proportions to provide the material mixture, and heating the material mixture, to at least partially liquefy the material mixture. The mold cavity, configured to form the element, is provided. As described above, the element preferably includes the central plate partially defined by the central plane thereof, and the at least partially spherical central part centrally located on the central plate, the central part being at least partially defined by the central axis thereof positioned orthogonal to the central plane. The element preferably also includes the ribs converging at respective points on opposite sides of the central part that are aligned with the central axis. The at least partially liquefied material mixture is injected into the mold cavity in the series of at least three steps commencing with the initial one of the three or more steps. In each of the three or more steps the material mixture is injected over the predetermined time period therefor at the predetermined velocity therefor and under the predetermined pressure therefor. Each predetermined velocity in the steps following the initial one of the three or more steps is less than the predetermined velocity in an immediately preceding step thereof, and each predetermined pressure in the steps following the initial one of the three or more steps is less than the predetermined pressure in the immediately preceding step thereof.

It will be appreciated by those skilled in the art that, although the steps of the method described in the preceding paragraph are set out in a particular order, the sequence in which certain of these steps are described is not necessarily functionally significant. For instance, the mold cavity may first be provided.

In use, the elements 622 in the system 620 are deployed in the tank 610 either after the liquid hydrocarbons 613 have been introduced therein, or before. As described above, a sufficient number of the elements 622 is used that the surface 619 of the liquid hydrocarbon 613 is substantially covered by the elements 622. The elements 622 are allowed to position themselves under the influence of gravity so that they engage each other at their respective outward faces 638, to cover (or substantially cover) the surface 619 (FIG. 18). As can be seen in FIGS. 16A, 16B, and 18, the elements 622 are constrained by engagement with an interior surface 626 of the tank wall 628.

As described above, it has been determined that polypropylene, HDPE, and PE are not suitable materials for use with the liquid hydrocarbons 613. It has also been determined that a polyamide polymer is suitable. Accordingly, and as noted above, in one embodiment, the polymer resin preferably is a polyamide. Preferably, the polyamide polymer resin is Nylon 612.

As noted above, the specific gravity of Nylon 612 is approximately 1.07. However, the specific gravity of the liquid hydrocarbons 613 may be between about 0.626 and about 0.92, depending on the liquid hydrocarbon. It has been determined that, in order for the element 622 to be positioned as preferred when floating partly in and on the liquid hydrocarbons 613, the specific gravity of the element 622 preferably should be approximately 50 to 60 percent of the specific gravity of the liquid hydrocarbons 613. It is believed that this is likely to enable the element 622 to have a relatively long useful life, as described above. That is, if the liquid hydrocarbon has a specific gravity of about 0.92, then the element's specific gravity preferably should be approximately 0.46 or less, representing a decrease in density of approximately 57 percent, or more. This large density reduction has been achieved using the method of the invention. As noted above, the element 622 may be formed with a density of approximately 0.41 g/cc. (approximately 25.6 lbs/cu. ft.).

This is a surprising and unusual result, because it is generally understood that a density reduction of 30 percent is the most that can typically be achieved when utilizing standard injection molding equipment.

To practise the invention herein, standard injection molding equipment is used to inject the material mixture, as noted above. Those skilled in the art would appreciate that, in the typical injection molding machine, the heated resin (i.e., the material mixture) is pushed through the barrel 666 by a plunger 668, e.g., driven by a screw or a ram device (not shown). During an injection, the plunger travels from a first end 670 to a second end 672 (FIG. 19C). The second end 672 is in fluid communication with the mold cavity 660 and via a nozzle 674. (It will be understood that the material mixture and many components of the injection molding machine are omitted from FIG. 19C for clarity.)

The plunger 668, in moving from the first end 670 to the second end 672, injects the molten material mixture into the mold cavity 660 via the nozzle 674. When the plunger 668 arrives at the second end 672, the injection is completed, and substantially all the material mixture that was in the barrel 666 has been injected into the mold cavity 660. As described above, in the tooling (i.e., the mold assembly 654) used with the method of the invention, the only unusual features are the larger number of vents, and also the oversized vents.

Those skilled in the art would be aware that, in the prior art, the movement of the plunger from the first end to the second end is considered the first of two stages. In the second stage, the material injected into the mold cavity is “held” for a certain period of time. In the prior art, injection molding only involves these two stages.

In order to achieve the unusually large density reduction referred to above, the method of the invention involves a number of unusual steps and features. For instance, in one embodiment, it is preferred that the foaming agent makes up more than 1 percent by weight of the material mixture by weight, the balance being the polymer resin. It is preferred that the foaming agent comprises approximately 1.3 percent by weight of the material mixture. This is an unusually high concentration of foaming agent, as the maximum typically recommended is one percent. In order to ensure accuracy, it is preferred that a continuous loss-in, weigh system (utilizing dual load cells) is used. Those skilled in the art would be aware of suitable weighing and control systems.

As described above, it has been determined that the unusually large decrease in density is achievable when the material mixture is injected into the mold cavity in at least three steps. As noted above, in the first step, the material mixture is injected over the predetermined first time period, at the predetermined first velocity, and under the predetermined first pressure.

Those skilled in the art would be aware that the amount of time required for injection molding of a particular part depends, among other things, on the size (i.e., mass) of the part to be formed. For example, if the element 622 has a mass of approximately 286 grams (approximately 0.63 lbs.), then the total injection time is approximately 4.5 seconds.

Accordingly, it is believed that the predetermined time periods are most appropriately expressed herein in terms of the position of the plunger 668 in the barrel 666 during the process. For instance, in one embodiment, it is preferred that the first predetermined time period terminates when the plunger 668 is approximately at a halfway point (identified by reference numeral 676 in FIG. 19C) along the barrel 666, i.e., approximately halfway between the first and second ends 670, 672 of the barrel 666. In one embodiment, therefore, the first predetermined time period is the time in which the plunger 668 travels in the direction indicated by arrow “Z₁” in FIG. 19C from the first end 670 of the barrel 666 to the halfway point 676 on the barrel 666.

At the end of the first step, the second step begins. There is no time delay between the first and second steps. As noted above, the second step involves injecting the material mixture over the predetermined second time period, at the predetermined second velocity, and under the predetermined second pressure. The second predetermined time period is the time in which the plunger 668 travels in the direction indicated by arrow “Z₂” in FIG. 19C from the halfway point 676 to a location 678 that is approximately equidistant between the halfway point 676 and the second end 672. The second predetermined time period preferably terminates when the plunger reaches the location 678.

It will be understood that only one plunger 668 is located in the barrel 666. The plunger 668 is shown in dashed lines at two locations in FIG. 19C to indicate its movement.

Those skilled in the art would be aware of a suitable maximum velocity of injected material in a conventional injection molding machine. For example, a typical maximum velocity is approximately 240 mm/second (approximately 0.79 feet/second). Also, those skilled in the art would be aware of a suitable maximum pressure to which the injected material may be subjected. For instance, in one embodiment, the predetermined first pressure is approximately 21,000 psi (approximately 0.07 kg-force per square cm).

It is preferred that the second velocity is approximately 50 percent of the first velocity, and the second pressure is approximately 48 percent of the first pressure.

Once the second step is completed, the third step commences. There is no time delay between the second and third steps. The third step involves injecting the material mixture into the mold cavity 660 over the predetermined third time period. In accordance with the foregoing, in one embodiment, the predetermined third time period preferably is the time required for the plunger to move in the direction indicated by arrow “Z₃” in FIG. 19C from the aforesaid location 678 in the barrel 666 to the second end 672 of the barrel 666. It is also preferred that the third velocity is approximately 50 percent of the second velocity, and the third pressure is approximately 75 percent of the second pressure. From the foregoing, it can be seen that the decreases in the velocity preferably are linear, however, the decreases in pressure preferably are not linear.

It will be understood that the material mixture (not shown in FIG. 18C) is injected into the mold cavity 660 in the mold assembly or tooling 654 via the nozzle 674 in the direction indicated by arrow “A” in FIG. 19C.

By way of example, when the element 622 has a mass of approximately 286 grams (approximately 0.63 lbs.), in one embodiment, the first predetermined time period preferably is approximately 1.0 second, the second predetermined time period is approximately 1.5 second, and the third predetermined time period is approximately 2.0 seconds. Where the barrel extends 216 mm (approximately 8.5 inches), the halfway point 676 is at approximately 108 mm (approximately 4.25 inches) from the first end, and the location 678 is at approximately 54 mm (approximately 2.1 inches) from the second end 672. Where the element is 286 grams (approximately 0.63 lbs.), it has been found that, by the end of the first predetermined time period, 142 grams (approximately 0.31 lbs.) have been injected; by the end of the second predetermined time period, approximately 212 grams (approximately 0.47 lbs.) in total have been injected; and in the third predetermined time period, another approximately 74 grams (approximately 0.16 lbs.) are injected, i.e., for a total of approximately 286 grams (approximately 0.63 lbs.).

From the foregoing, it can also be seen that the method of the invention does not include a “hold” or “pack” stage that typically is a second stage in a conventional injection molding process, the first stage being injection. It has been found that, in the method of the invention, no hold stage is needed. Instead, the injection proceeds from the first step to the second step, and then from the second step to the third step, without stopping. Accordingly, the method of the invention differs significantly from the prior art method.

It has also been determined that the temperature of the material mixture preferably is about 30° F. (approximately 1.1° C.) lower than the usual temperature for polyamide polymers, e.g., about 470° F. (approximately 243.3° C.) at the nozzle, and otherwise about 450° F. (approximately 232.2° C.). Accordingly, in one embodiment, the temperature of the material mixture during the predetermined first, second, and third time periods is approximately 450° F. (approximately 232.2° C.). Those skilled in the art would appreciate that such a reduction in barrel temperature is unusual. In the method of the invention, however, it has been found to be advantageous so that the melt flow of the resin is reduced to a level that is more conducive to the foaming process.

It is also preferred that a mechanical shut-off tip serves as the gateway from the barrel of the injection molding machine to the injection mold assembly 654. The shut-off tip prevents pressure from the barrel of the machine from “choking” off the expansion in the mold cavity.

It has been found that, utilizing the method of the invention, the element 622 produced according thereto may have a specific gravity of approximately 0.41. Preferably, the specific gravity of the element 622 formed according to the method of the invention is approximately 0.41, so that the element 622 may float on the liquid hydrocarbons for a suitably lengthy time period before sufficient liquid hydrocarbons migrate into the element to cause it to sit so low in the liquid hydrocarbons that the liquid hydrocarbons cover the central plate 634. At that point, because it is too dense to function as intended, the element 622 should be replaced by a newly-formed element 622.

As described above, the very large reduction in density of the polyamide polymer resin is achieved by adopting the unusual process described above. In addition, the element 622 formed using the method of the invention has substantially uniform internal cellular structures, which is advantageous for the reasons set out above. An unexpected benefit of employing the method of the invention is that it results in the elements 622 having unusually good anti-static characteristics. The reasons for this phenomenon are not well understood at this time. However, it is an important benefit, because it means that no additives or treatments are needed in order for the elements 622 to have the desired anti-static surface characteristics.

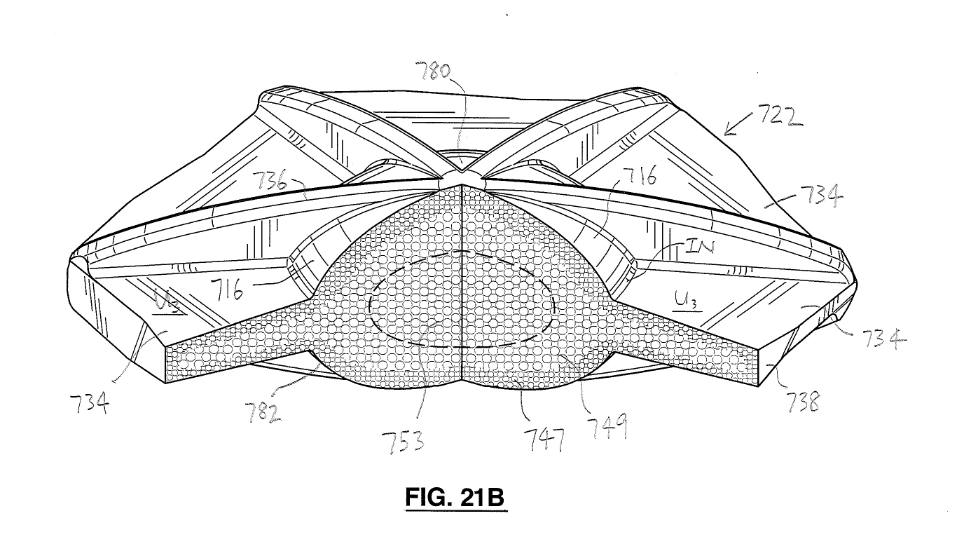

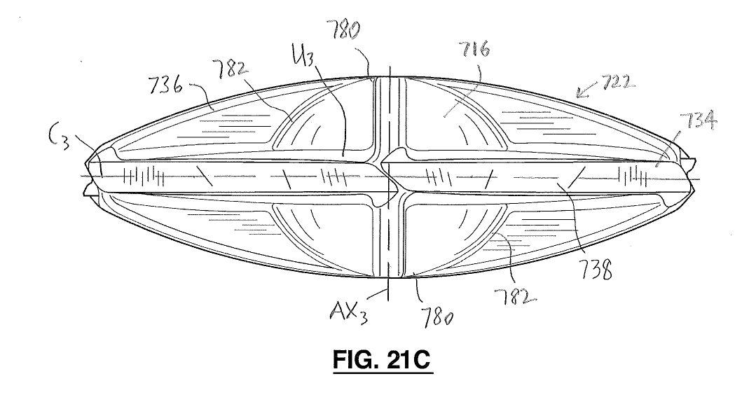

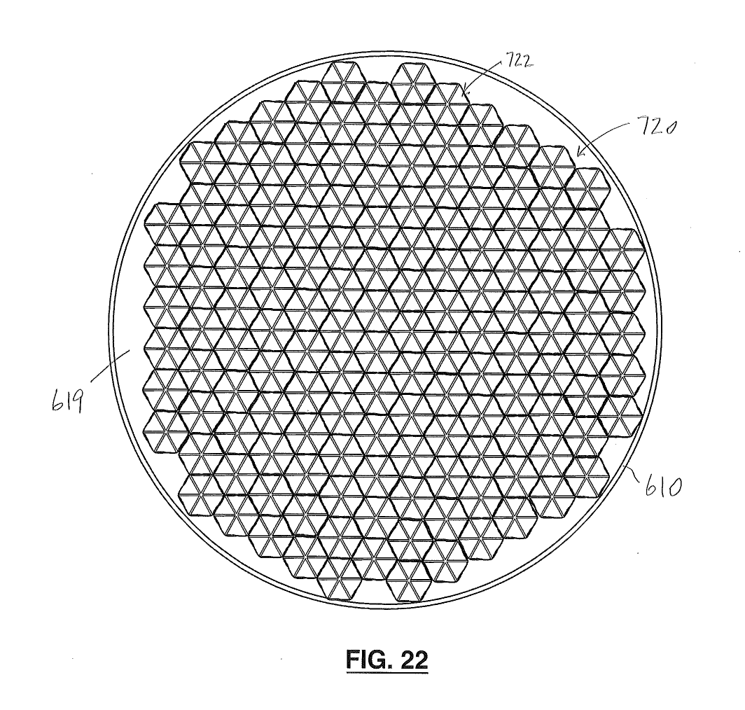

Another alternative embodiment of the element 722 of the invention is illustrated in FIGS. 21A-21C. An embodiment of a system 720 of the invention, including the elements 722, is also illustrated in FIG. 22. As can be seen in FIGS. 21A-21C, a central part 716 of the element 722 is generally in an ellipsoid form, except to the extent that the central part 716 intersects with ribs 736. Flattened areas 780 of the central part 716 can be seen in FIGS. 21A-21C. The flattened areas 780 are flattened relative to adjacent areas 782 of the central part 716, which are formed to be consistent with a generally spherical central part. That is, the side or adjacent areas 782 are generally consistent with an overall spherical shape.

Although a sphere has the lowest ratio of surface area to the volume, in the element 722, a generally flattened sphere (i.e., an ellipsoid as illustrated in FIGS. 21A and 21B) is better suited for reducing surface area of the element because the ellipsoid 716 may be formed to have a suitably lower profile. The central part 716 has been found to result in a reduction in total surface area of the element 722, i.e., as compared to that of the element 622.

The element 722 preferably has a central plate 734, and a number of outward faces 738 that give the central plate 734 a generally hexagonal shape, in plan view. As can be seen in FIG. 21B, it is preferred that the central plate 734 is also tapered between its intersection with the central part 716 and the outward faces 738, being thicker at the intersection of the central plate 734 with the central part 716, and thinner at the outward faces 738. In FIG. 21B, the intersection of an upper surface “U₃” of the central plate 734 with the ellipsoid central part 716 is identified at “IN” for convenience. Due to the tapered shape of the central part 734, any of the liquid hydrocarbons that becomes positioned on the upper surface “U₃” drain off the upper surface.

It will be understood that the element 722 is formed generally in the same way as the element 622, described above, subject to the central part 716 being formed to have a generally ellipsoid shape, unlike the central part 616 of the element 622, which has a generally spherical shape. Preferably, the element 722 is formed of Nylon 612, or any other suitable material. Accordingly, and as illustrated in FIG. 21B, the material of the element 722 preferably includes a relative finely formed cell structure (i.e., a matrix of Nylon 612, with voids therebetween) in a first layer 747 and a more coarsely-grained structure (also a matrix of Nylon 612, with voids) in second and third layers 749, 753 formed inwardly from the first layer 747.

The internal structure of the element 722 is similar to that of the element 622, described above. Preferably, the material (i.e., preferably Nylon 612) forms a matrix in which voids are formed. It will be understood that the voids in each layer 747, 749, 753 may not be formed as respectively precisely uniform as illustrated in FIG. 21B. The layers 747, 749, 753 as illustrated are a schematic representation of the internal structure of the element 722.

Replacing the generally spherical central part 616 of the element 622 with the somewhat larger ellipsoid central part 716 of the element 722 results in the element 722 having less surface area overall. With the central part 716 having the generally ellipsoid shape, the element's surface area is reduced so that the density of the element 722 is approximately 0.375 g/cc. Because the density of the element 722 is approximately 0.375 g/cc (approximately 23.4 lbs/cu. ft.), the element 722 may be used with liquid hydrocarbons 613 having relatively low densities, e.g., pentane, with a specific gravity of 0.626.

The element 722 preferably includes the central plate 734, which is partially defined by a central plane “C₃” (FIG. 21B). The element 722 preferably also includes the at least partially ellipsoid central part 716 centrally located on the central plate 734, the central part 716 being at least partially defined by a central axis “AX₃” thereof positioned orthogonal to the central plane “C₃” (FIG. 21C). It is also preferred that the element 722 includes a number of the ribs 736 converging at points on opposite sides of the ellipsoid central part that are aligned with the central axis “AX₃”.

As noted above, the element 722, having a substantially ellipsoid central part 716, preferably has a specific gravity of at least approximately 0.375. It has also been found that the element 722 has a surface resistivity of approximately 3.3×10⁹ Ohms per square. As noted above, with such a surface resistivity, the element 722 is considered to have antistatic properties. Accordingly, the element 722 is unlikely to cause a dangerous static discharge inside the tank.

As noted above, the system 720 preferably includes a number of the elements 722 in which the elements are engaged with each other to substantially cover the surface 619 of the liquid hydrocarbons 613, for impeding emission of vapors from the liquid hydrocarbons 613 via the surface 619 thereof (FIG. 22).

In use, the elements 722 in the system 720 are deployed in the tank 610 either after the liquid hydrocarbons 613 have been introduced therein, or before. As described above, it is preferred that a sufficient number of the elements 722 is used that the surface 619 of the liquid hydrocarbon 613 is substantially covered by the elements 722. The elements 722 are allowed to position themselves under the influence of gravity so that they engage each other at their respective outward faces 738, to cover (or substantially cover) the surface 619 (FIG. 18). Preferably, the elements 722 are constrained by engagement with an interior surface 726 of the tank wall 728.

From the foregoing, it can be seen that the elements 622, 722 and the embodiments of the system 620, 720 of the invention have a number of benefits. First, the system of the invention does not require operational costs to be incurred. Second, the system of the invention is relatively robust, and can be allowed to remain in the tank for several years.

The overall geometry of the elements 622, 722 (i.e., hexagonal in plan view) is such that the elements cover a greater percentage of the liquid surface 619 as the tank diameter is increased. This makes it ideal for the very large super tanks that are too large to have either an external pontoon roof or an internal tank pontoon roof.

In tanks that have a VRU attached to a fixed roof, the system of the invention substantially suppresses the vapor, so that total vapor load is reduced. Using the system, therefore, has the benefit that existing VRU may have less of a vapor load, or may enable the operator to proceed without increasing VRU capacity.

Conventional light oil storage facilities with fixed roof tanks are often located in hotter climates, and their VOC losses tend to be significant. If the system of the invention is used in such storage facilities, the material losses will be significantly reduced, the VOC emissions will be similarly improved and local hazards to health and safety greatly improved.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A method of forming at least one element to have a preselected element density, for floating at least partially on a surface of an at least partially liquid hydrocarbon mixture having a known liquid density, the method comprising:
(a) determining the preselected element density based on the known liquid density, the preselected element density being not greater than a predetermined proportion of the known liquid density;
(b) providing a mold cavity formed to define an exterior surface of said at least one element with an exterior surface area formed to provide said at least one element having the preselected element density;
(c) mixing a polymer resin and a foaming agent together in preselected proportions to provide a material mixture;
(d) heating the material mixture, to at least partially liquefy the material mixture;
(e) injecting the at least partially liquefied material mixture into the mold cavity over a predetermined first time period at a predetermined first velocity and under a predetermined first pressure to provide a first layer of first material at least partially forming the exterior surface of said at least one element;
(f) at the end of the first predetermined time period, injecting the at least partially liquefied material mixture into the mold cavity over a predetermined second time period at a predetermined second velocity that is less than the first velocity, and under a predetermined second pressure that is less than the first pressure, to provide a second layer of second material on the first material that is less dense than the first material; and
(g) at the end of the second predetermined time period, injecting the at least partially liquefied material mixture into the mold cavity over a predetermined third time period at a predetermined third velocity that is less than the second velocity, and under a third pressure that is less than the second pressure, to provide a third layer of third material that is less dense than the first material.

2. A method according to claim 1 in which the polymer resin is a polyamide.

3. A method according to claim 2 in which the polyamide polymer resin is Nylon 612.

4. A method according to claim 1 in which the foaming agent comprises more than 1 percent of the material mixture by weight, the balance being the polymer resin.

5. A method according to claim 1 in which the second velocity is approximately 50 percent of the first velocity, and the second pressure is approximately 48 percent of the first pressure.

6. A method according to claim 5 in which the third velocity is approximately 50 percent of the second velocity, and the third pressure is approximately 75 percent of the second pressure.

7. A method according to claim 2 in which the temperature of the material mixture during the predetermined first, second, and third time periods is approximately 450° F. (approximately 232.2° C.).

8. An element formed according to the method of claim 1 comprising:
a central plate partially defined by a central plane;
an at least partially spherical central part centrally located on the central plate, the central part being at least partially defined by a central axis thereof positioned orthogonal to the central plane; and
a plurality of ribs converging at points on opposite sides of the central part that are aligned with the central axis.

9. An element according to claim 8 having a specific gravity of at least approximately 0.41.

10. An element according to claim 8 having a surface resistivity of approximately 3.3×10⁹ Ohms per square.

11. A system comprising a plurality of the elements according to claim 8 in which the elements are engaged with each other to substantially cover the surface of the liquid hydrocarbon mixture, for impeding emission of vapors from the liquid hydrocarbon mixture via the surface thereof.

12. An element formed according to the method of claim 1 comprising:
a central plate partially defined by a central plane;
an at least partially ellipsoid central part centrally located on the central plate, the central part being at least partially defined by a central axis thereof positioned orthogonal to the central plane; and
a plurality of ribs converging at points on opposite sides of the ellipsoid central part that are aligned with the central axis.

13. An element according to claim 12 having a specific gravity of at least approximately 0.375.

14. An element according to claim 12 having a surface resistivity of approximately 3.3×10⁹ Ohms per square.

15. A system comprising a plurality of the elements according to claim 12 in which the elements are engaged with each other to substantially cover the surface of the liquid hydrocarbon mixture, for impeding emission of vapors from the liquid hydrocarbon mixture via the surface thereof.

16. A method of forming at least one element to float at least partially on a surface of an at least partially liquid hydrocarbon mixture, the method comprising:
(a) mixing a polymer resin and a foaming agent together in preselected proportions to provide a material mixture;
(b) heating the material mixture, to at least partially liquefy the material mixture;
(c) providing a mold cavity configured to form said at least one element comprising:
a central plate partially defined by a central plane;
an at least partially spherical central part centrally located on the central plate, the central part being at least partially defined by a central axis thereof positioned orthogonal to the central plane;
a plurality of ribs converging at respective points on opposite sides of the central part that are aligned with the central axis;
(d) injecting the at least partially liquefied material mixture into the mold cavity over a predetermined first time period at a predetermined first velocity and under a predetermined first pressure to form a first layer of the material mixture defining an exterior surface of said at least one element;
(e) at the end of the first predetermined time period, injecting the at least partially liquefied material mixture into the mold cavity over a predetermined second time period at a predetermined second velocity that is less than the first velocity, and under a predetermined second pressure that is less than the first pressure to form a second layer of the material mixture on the first layer; and
(f) at the end of the second predetermined time period, injecting the at least partially liquefied material mixture into the mold cavity over a predetermined third time period at a predetermined third velocity that is less than the second velocity, and under a third pressure that is less than the second pressure to form a third layer of the material mixture on the second layer.

17. A method of forming at least one element to float at least partially on a surface of an at least partially liquid hydrocarbon mixture, the method comprising:
(a) mixing a polymer resin and a foaming agent together in preselected proportions to provide a material mixture;
(b) heating the material mixture, to at least partially liquefy the material mixture;
(c) providing a mold cavity configured to form said at least one element comprising:
a central plate partially defined by a central plane;
an at least partially ellipsoid central part centrally located on the central plate, the central part being at least partially defined by a central axis thereof positioned orthogonal to the central plane;
a plurality of ribs converging at respective points on opposite sides of the central part that are aligned with the central axis;
(d) injecting the at least partially liquefied material mixture into the mold cavity over a predetermined first time period at a predetermined first velocity and under a predetermined first pressure to form a first layer of the material mixture defining an exterior surface of said at least one element;
(e) at the end of the first predetermined time period, injecting the at least partially liquefied material mixture into the mold cavity over a predetermined second time period at a predetermined second velocity that is less than the first velocity, and under a predetermined second pressure that is less than the first pressure to form a second layer of the material mixture on the first layer; and
(f) at the end of the second predetermined time period, injecting the at least partially liquefied material mixture into the mold cavity over a predetermined third time period at a predetermined third velocity that is less than the second velocity, and under a third pressure that is less than the second pressure to form a third layer of the material mixture on the second layer.

18. A method of forming at least one element to float at least partially on a surface of an at least partially liquid hydrocarbon mixture, the method comprising:
(a) mixing a polymer resin and a foaming agent together in preselected proportions to provide a material mixture;
(b) heating the material mixture, to at least partially liquefy the material mixture;
(c) providing a mold cavity configured to form said at least one element comprising:
a central plate partially defined by a central plane;
an at least partially spherical central part centrally located on the central plate, the central part being at least partially defined by a central axis thereof positioned orthogonal to the central plane;
a plurality of ribs converging at respective points on opposite sides of the central part that are aligned with the central axis; and
(d) injecting the at least partially liquefied material mixture into the mold cavity in a series of at least three steps commencing with an initial one of said at least three steps, in each of said at least three steps the material mixture being injected over a predetermined time period at a predetermined velocity and under a predetermined pressure, each said predetermined velocity in the steps following the initial one of said at least three steps being less than said predetermined velocity in an immediately preceding step thereof, and each said predetermined pressure in the steps following the initial one of said at least three steps being less than said predetermined pressure in the immediately preceding step thereof.

19. A method of forming at least one element to float at least partially on a surface of an at least partially liquid hydrocarbon mixture, the method comprising:
(a) mixing a polymer resin and a foaming agent together in preselected proportions to provide a material mixture;
(b) heating the material mixture, to at least partially liquefy the material mixture;
(c) providing a mold cavity configured to form said at least one element comprising:
a central plate partially defined by a central plane;
an at least partially ellipsoid central part centrally located on the central plate, the central part being at least partially defined by a central axis thereof positioned orthogonal to the central plane;
a plurality of ribs converging at respective points on opposite sides of the central part that are aligned with the central axis; and
(d) injecting the at least partially liquefied material mixture into the mold cavity in a series of at least three steps commencing with an initial one of said at least three steps, in each of said at least three steps the material mixture being injected over a predetermined time period at a predetermined velocity and under a predetermined pressure, each said predetermined velocity in the steps following the initial one of said at least three steps being less than said predetermined velocity in an immediately preceding step thereof, and each said predetermined pressure in the steps following the initial one of said at least three steps being less than said predetermined pressure in the immediately preceding step thereof.
